(19) United States
(12) Patent Application Publication
(10) Pub. No.: US 2008/0059571 A1
(43) Pub. Date: Mar. 6, 2008

(54) Displaying Advertising Messages in the Unused Portion and During a Context Switch Period of a Web Browser Display Interface

(76) Inventor: Soon Huat Khoo, Alameda, CA (US)

Correspondence Address: COURTNEY STANIFORD & GREGORY LLP, P.O. BOX 9686, SAN JOSE, CA, 95157, US

(21) Appl. No.: 11/927,578

(22) Filed: Oct. 29, 2007

Related U.S. Application Data
(63) Continuation-in-part of application No. 11/180,363, filed on Jul. 13, 2005.
Application No. 11/180,363 is a continuation of application No. 09/808,815, filed on Mar. 14, 2001, now Pat. No. 6,934,743.

(51) Int. Cl. G06F 15/16; G06Q 30/00

(52) U.S. Cl. 709/203; 705/14

(57) ABSTRACT

A system for displaying intermediate message content over the unused area of a web browser is described. An intermediate message display process is linked to the web browser program executed on a client computer. The process monitors user activity on the client computer and identifies areas of the web browser display area that are not used. Upon detection of an unused clear space within the web browser display area, an intermediate message is displayed in the clear area of the web browser. The intermediate message could be an advertisement display provided by a third party content provider. A timer process and clear space detection routine within the intermediate message display process govern the display of the intermediate message in accordance with specified background pattern and message window dimension parameters.

### CROSS-REFERENCE TO RELATED APPLICATIONS

The present application is a Continuation-in-Part application of currently pending U.S. application Ser. No. 11/180,363 entitled “Method and Apparatus for Displaying Intermediate Content Messages in the Unused Portion of a Web Browser Display Space,” filed on Jul. 13, 2005, which is a Continuation Application of U.S. application Ser. No. 09/808,815, filed on Mar. 14, 2001 and entitled “Displaying Advertising Messages in the Unused Portion of a Web Browser Display Space,” which is now issued as U.S. Pat. No. 6,934,743.

### FIELD OF THE INVENTION

The present invention relates generally to World-Wide Web based computer networks, and more specifically, to a system for displaying advertising messages in the display areas of limited size.

### BACKGROUND OF INVENTION

Data transmitted over the Internet is typically provided in the form of web pages that are served by a web server process running on a server computer and accessed by a web browser process running on a client computer. Many different types of content can be provided within a web page, including static text or graphic information, links to other web pages, and streaming audio or video, all in different display areas of a page.

Because of the amount of information that is typically provided in average web pages, display space is at a premium. This is especially true for devices with relatively small display areas, such as cell phones, small notebook computers, and other handheld mobile devices. Often, web pages contain information that is additional to the content that comprises the downloaded web page. The primary example of such supplemental or intermediate information is an advertising message. In present web based systems, advertising messages are frequently provided in the form of “pop-up” banner ads that occupy or cover a portion of the web display area. This often results in a crowded web display area in which the ad content displaces some of the actual downloaded content. Moreover, many current pop-up message systems cause a pop-up message to appear in a window that covers or interferes with a portion of the active window that the user is viewing. This can be annoying since it interrupts the user's viewing experience and forces the user to close the pop-up message window or send it to the background.

Various different opportunities exist for maximizing the display of intermediate messages in a way that does not significantly interfere with the user's web page viewing experience. These include exploiting both the space available within a web page as well as the time intervals taken by certain processes in performing display tasks.

In many cases, while the user is viewing the content of the web page or clicking on embedded links, certain areas of the browser window are typically unused. In some web browser programs, these unused areas, also referred to as “clear space” can constitute a significant percentage (e.g., 25%) of the total web browser display area. A disadvantage of present web browser systems is that this unused clear space is under-utilized for the display of intermediate content data. Instead, current systems randomly place pop-up message windows within the active viewing area, thus potentially covering content that the user desires to view.

Other display areas of the web browser window may include constant graphic elements or elements that that do not change significantly over time. Such areas may include the taskbar or tool bar areas that display control buttons that access and invoke various commands. Such areas are also underutilized by present systems in that they are often restricted to the display of constant static images that may be largely ignored by a user during use of the web page.

Because of the finite bandwidth of computers and data transmission equipment, there are certain inevitable delays that are encountered when accessing computer sites over a network such as the Internet. Such delays are often caused by transmission delays associated with the TCP/IP protocol of the Internet, slow modem or network interface device speeds, high volumes of traffic causing server overloads, and other similar factors. The increasing complexity of data as well as the increasing volume of data transmitted over the Internet also contributes to delays in accessing particular sites, or accessing sites during particular times. This is especially true of sites that offer downloads of video clips, audio samples, executable programs, and the like. Although network equipment designs continue to improve and the push to broadband network capacities evolves, the volume of data transmitted over these networks is also expected to increase. Therefore, access delays and transmission latencies will almost always be present, at least to some degree.

Much of the delay presently encountered in accessing web pages is associated with switching from one page to another. Because information provided by a web server is often provided in the form of discrete pages, switching from one page to another during the course of accessing a site or surfing the web is a frequent occurrence for the typical web user. For example, users often switch between pages to access other web sites or regions within a particular web site. During the period of switching between pages, the computer is usually idle. Processing is typically suspended while the client computer accesses the new server computer location and downloads the data for display on the client computer. This idle time represents a potentially significant resource with regard to user attention. Because web page changes happen within a relatively short period of time, e.g., 3 to 5 seconds, most users typically wait for the page change to occur without averting their attention from the computer. Thus, during web page changes, the user is waiting for an event to happen within a short period of time and is essentially an idle captive audience. It has been estimated that, in some cases, up to 25 percent of a user's time on the Internet is spent waiting for web pages to load. One present drawback of typical present Internet applications is that this idle time is not exploited.

### INCORPORATION BY REFERENCE

Each publication, patent, and/or patent application mentioned in this specification, including U.S. patent application Ser. No. 11/180,363 filed Jul. 13, 2005, and U.S. patent application Ser. No. 09/808,815 filed Mar. 14, 2001 (Now U.S. Pat. No. 6,934,743) is herein incorporated by reference in its entirety to the same extent as if each individual publication and/or patent application was specifically and individually indicated to be incorporated by reference.

### BRIEF DESCRIPTION OF THE DRAWINGS

The present invention is illustrated by way of example and not limitation in the figures of the accompanying drawings, in which like references indicate similar elements, and in which:

FIG. 1 illustrates a block diagram of a computer network system that implements embodiments of the present invention;

FIG. 2 illustrates the display screen of an exemplary web page as displayed in a client computer that includes various display fields as well as clear space that is recognized by the clear space display process, according to one embodiment of the present invention;

FIG. 3A illustrates an exemplary web page with a recognized clear space area in a first scrolled position, according to one embodiment of the present invention;

FIG. 3B illustrates the exemplary web page of Figure in a second scrolled position;

FIG. 4 is a flowchart that illustrates the process of identifying and displaying intermediate messages in the clear space of a displayed web page, according to one embodiment of the present invention;

FIG. 5 is a flowchart that illustrates to process of displaying intermediate messages in the clear space of a scrolled web page, according to one embodiment of the present invention;

FIG. 6A illustrates a web browser window in which an automatic taskbar overlay is generated and displayed over the taskbar area of a web browser;

FIG. 6B illustrates the movement of the cursor from a first position from the taskbar to a second position within a web display area;

FIG. 7 is a flowchart that illustrates the process of displaying an intermediate message in an automatic taskbar overlay by monitoring the activity of the taskbar controls and the position of the cursor, according to an embodiment;

FIG. 8 is a flowchart that illustrates how the automatic taskbar overlay process monitors the idle time of the cursor, under an embodiment;

FIG. 9 is a flowchart that illustrates a method of determining taskbar size and location, under an embodiment;

FIG. 10 is a flowchart that illustrates the process of displaying an intermediate message using rules that govern the duration of the browser instance and timer variables, according to an embodiment;

FIG. 11 is a decision table that illustrates the conditions and rules governing the display of an intermediate message in a client web browser, according to an embodiment;

FIG. 12 is a flowchart that illustrates the operation of the client intermediate message display process, according to an embodiment;

FIG. 13 illustrates a system including a dedicated client web browsing process that incorporate the intermediate message display process, under an embodiment;

FIG. 14 is a block diagram that illustrates an intermediate message display process integrated with a standard web browser, according to an alternative embodiment; and

FIG. 15 is a block diagram that illustrates an intermediate message display process integrated with a standard web browser, according to a further alternative embodiment.

### DETAIL DESCRIPTION OF EMBODIMENTS

Embodiments of a system for displaying intermediate message content in static or unused areas of a web page are described. An intermediate message display process is linked to the web browser program executed on a client computer. The process monitors user activity on the client computer and identifies areas of the web browser display area that are not used. Upon detection of an unused clear space within the web browser display area or an area with static content, an intermediate message is displayed in this area of the web browser. A timer process and clear space detection routine within the intermediate message display process govern the display of the intermediate message in accordance with specified background pattern and message window dimension parameters. Embodiments are also directed to a system for displaying intermediate content during a web browser context switching event is described. An intermediate message display process is linked to the web browsing program executed on a client computer. The process monitors user activity on the client computer and identifies triggering context switching events such as the switching of web pages using the web browser. Upon the occurrence of a browser instance, an intermediate message is displayed within the main display window of the web browser. Such a message could be an advertisement provided by a third party content provider. A timer process and rule generation engine within the intermediate message display process govern the display of the intermediate message in accordance with specified timing parameters and browser instance parameters. Through these embodiments, aspects of the present invention generally provide an improved Internet advertising message delivery system.

In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Hardware Overview

Aspects of the present invention may be implemented on one or more computers executing software instructions. According to one embodiment of the present invention, server and client computer systems transmit and receive data over a computer network or standard telephone line. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention. The instructions may be loaded into the memory of the server or client computers from a storage device or from one or more other computer systems over a network connection. For example, a client computer may transmit a sequence of instructions to the server computer in response to a message transmitted to the client over a network by the server.

As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, or to any particular source for the instructions executed by the server or client computers.

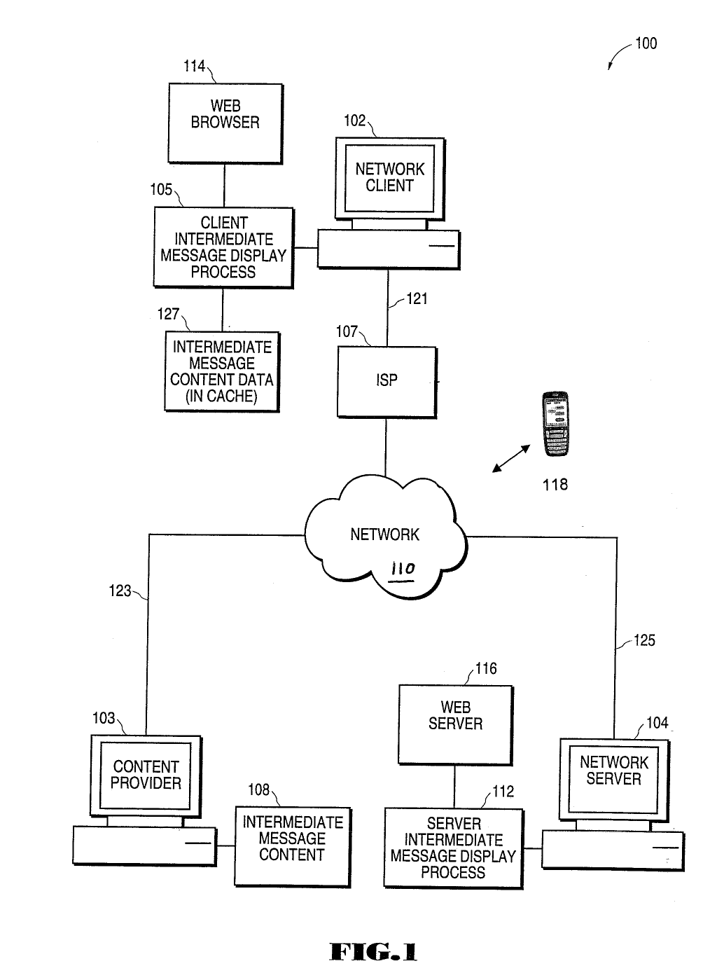

FIG. 1 illustrates a computer network system 100 that implements one or more embodiments of the present invention. In system 100, a network server computer 104 is coupled, directly or indirectly, over line 125 to one or more network client computers 102 through a network 110. The network interface between server computer 104 and client computer 102 may also include one or more routers that serve to buffer and route the data transmitted between the server and client computers over line 121. Network 110 may be the Internet, a Wide Area Network (WAN), a Local Area Network (LAN), or any combination thereof.

In one embodiment of the present invention, the server computer 104 is a World-Wide Web (WWW) server that stores data in the form of ‘web pages’ and transmits these pages as Hypertext Markup Language (HTML) files over the Internet network 110 to the client computer 102. For this embodiment, the client computer 102 typically runs a “web browser” program 114 to access the web pages served by server computer 104 and content provider 103. In one embodiment of the present invention, server 104 in network system 100 is a server that executes a server side intermediate message display process 112. Client versions of the intermediate message display process 105 may also be executed on the client computers, such as client computer 102.

The intermediate message display process 112 may represent one or more executable program modules that are stored within network server 104 and executed locally within the server. Alternatively, however, it may be stored on a remote storage or processing device coupled to server 104 or network 110 and accessed by server 104 to be locally executed. In a further alternative embodiment of the present invention, intermediate message display process 112 may be implemented in a plurality of different program modules, each of which may be executed by two or more distributed server computers coupled to each other, or to network 110 separately. In one embodiment of the present invention, wherein network 110 is the Internet, network server 104 executes a web server process 116 to provide HTML documents, typically in the form of web pages, to client computers coupled to network 110. To access the HTML files provided by server 104, client computer 102 runs a web browser 114 that accesses web pages available on server 104 and other Internet server sites, such as content provider 103 (which may also be a network server executing a web server process).

It should be noted that a network system 100 that implements embodiments of the present invention may include a larger number of interconnected client and server computers than shown in FIG. 1. For this embodiment, the client computer 102 may access the Internet network 110 through an Internet Service Provider (ISP) 107. In one embodiment of the present invention, a separate content provider 103 may provide the data that comprises the intermediate messages 108. Alternatively, this content may be provided directly by the server computer 104. Another class of client computers is represented by mobile client 118. Mobile client 118 can be a mobile computing or communication device, such as a notebook computer, personal digital assistant (PDA), mobile phone, game console, or any similar class of mobile computing device with sufficient processing, communication, and message display capability. Typically, such mobile devices contain relatively small display screens in which display area is at a premium. Mobile client devices may access network 110 through other networks, such as cell networks and the like.

As can be appreciated by those of ordinary skill in the art, the representative networked computers of FIG. 1, such as network server computer 104 can be implemented as any standard computer, such as personal computers, laptop computers, mainframe computers, or other type of workstation computers. The computers in FIG. 1 could also be implemented in the form of portable or miniaturized computing devices, such as handheld personal digital assistants (PDA), including devices that communicate with other devices on the network over a wireless medium. In certain systems, the client computer can also be implemented as a dedicated Internet client.

Clear Space Intermediate Message Display Process

In one embodiment of the present invention, the intermediate message display process 105 comprises a client side clear space display process that is executed by network client 105. The client side clear space display process 105 displays an intermediate message content in the unused or clear areas of web browser 114 displayed on the client 102. The intermediate message content can comprise text or graphic messages, such as pop-up advertisements or other similar messages. These messages can be stored or cached locally on the network client 102 such as through an intermediate message content data storage location 127, or the intermediate message content can be transmitted to the network client 102 over the network 110 from a content provider 103. In this case, the actual data comprising the intermediate message can be stored in a data storage device 108 coupled to the content provider computer 103. For this embodiment, the content provider 103 acts as a repository of intermediate messages for upload to the network client 102.

In general, the unused area of a display in which an intermediate message is displayed is any area of a screen that does not include purposeful content that is provided by a content provider 103 or other similar party. It can be a blank or unicolor portion of a web browser or other user interface screen. Certain unicolor portions of the screen may appear to be unused, but may instead form part of the actual content of the displayed image. An example might be a large portion of a monocolor image (e.g., the side of a plain house). Embodiments of the intermediate display process include processes that differentiate true unused portions of a display from mono-color display elements. The unused area of a display may also include portions of the screen that do not display content, but may display static elements that are part of the browser or application program, but are not provided by the content provider as part of the content. Examples include the taskbar or toolbar region of the web browser, and the like. These areas display useful elements, but do no constitute part of the display populated by the content provider. A user may not require part, or even all of such areas during the course of viewing a particular web page. Therefore, such areas are also referred to as unused areas.

In one embodiment, the client side clear space display process 105 is transmitted to the network client 102 by network server 104 from a server side clear space display process 112. Once the clear space display process is downloaded to the client computer, it is stored locally and executed in conjunction with the client web browser program 114. For this embodiment, the clear space display process is only downloaded once to the client computer from the server computer, and is thereafter executed locally. In an alternative embodiment, the clear space display process executed over the network by the network client 102 from network server 104 as a server resident clear space display process 112 whenever the client web browser program 114 is executed. This method may slow execution time of the clear space display process since the program is executed over a network rather than locally, but requires less storage space on the network client 102. The clear space display processes 105 serves to generate and display intermediate messages, such as pop-up advertisements, in the unused areas of web browser 114.

When a user is viewing a downloaded web page, much of the web page display area may be unoccupied. The clear space display process includes a process that identifies empty spaces within the displayable portions of the client computer display device. For the embodiment in which the client computer executes a web browser program 114, the clear space display process 105 recognizes empty spaces within the web page displayed by the web browser. The clear spaces identified by the clear space display process conform to dimensions that correspond to the size of the message to be displayed.

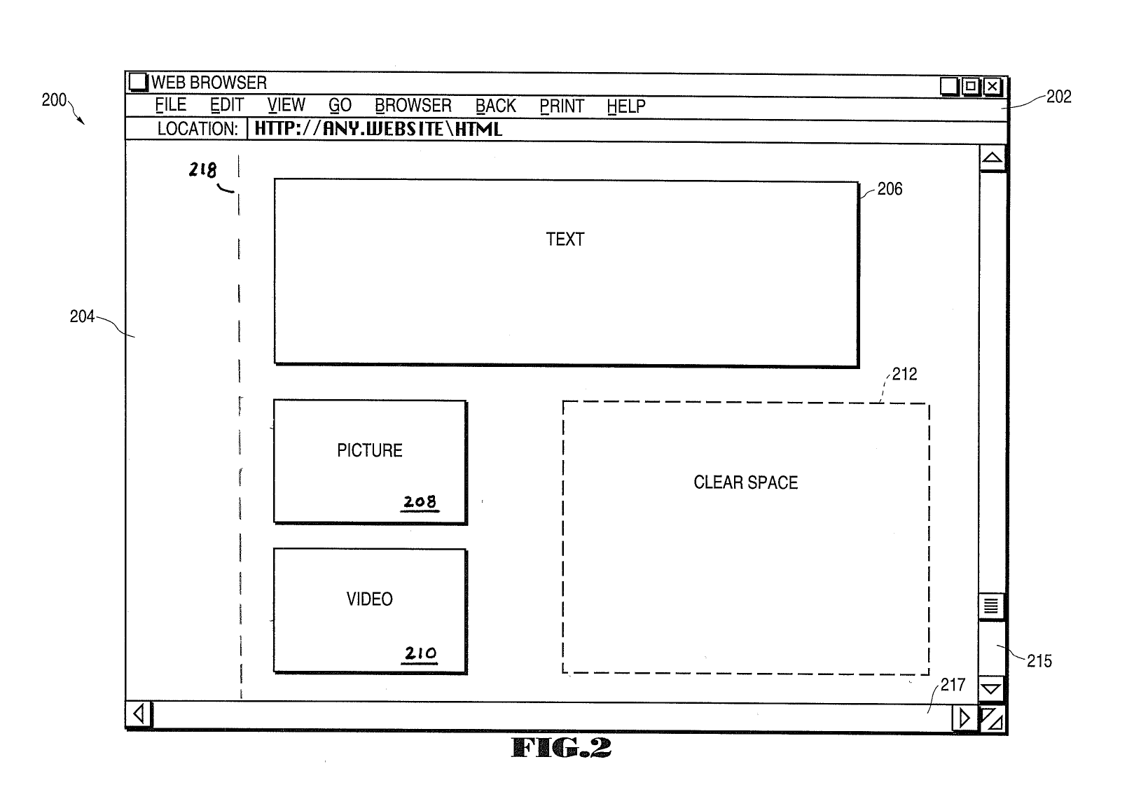

FIG. 2 illustrates a web page that includes various display fields as well as clear space that is recognized by the clear space display process. Taskbar 202 contains various command or command icons for navigating around web sites and performing various functions. The taskbar 202 can also include an area that displays the URL (address) of the displayed web page. The main section of web page 200 is display area 204. This area displays the contents of the web page at the specified URL. For the example illustrated in FIG. 2, web page 200 includes a text area 206 that contains lines of text. The exemplary web page 200 also includes a window 208 for displaying graphical content, such as still pictures or banner advertisements. Depending on the content contained in a web page, many types of content and formats are possible. For example, another window 210 may be used to display streaming video content through the web page. A typical web browser program also includes a vertical scroll bar 215 and horizontal scroll bar 217 that allow the user to scroll the displayed web page up/down or left/right to view other areas of the web page.

Many web pages include some amount of empty or clear space. Typically, this is unused space within the web page that is not being used to display purposeful content such as text 206, graphics 208, or any other type of actual content. Sometimes however, such clear space may not be totally devoid of content in that it may contain color or a background pattern that presents a uniform visual display that does not change over time, that is, a unicolor pixel display area. Technically though, even if such a clear space is not displayed as a plain white area, this space can be considered unused by the web page being accessed. In certain cases, however, a unicolor display area may be part of display that should not be obstructed by an intermediate message. Embodiments of the intermediate message display process are configured to only display intermediate messages in a pre-defined zone within the display area, regardless of where any such unicolor pixel display areas may be. For example, true unused clear spaces may more often be present around the edge areas or margin areas of a web page, in which case the display process is configured to display messages only in clear spaces found within these margin areas. This is illustrated in FIG. 2 as virtual margin line 218. For this embodiment, intermediate messages may be displayed only for clear spaces found to one side or the other (e.g., outside) of margin line 218. Any number of margin lines may be defined for the X-Y coordinates of the total display area 204. Thus, for example, the process can be configured to display intermediate messages only within a one inch margin around the perimeter of display area 204, or any similar definition of limited display area for intermediate messages.

In one embodiment of the present invention, the clear space display process identifies and measures the available clear space within a displayed web page. The empty space 212 is defined by XY coordinates of a boundary that encloses the unused empty space. The XY coordinates of the boundary define both the size of the empty space and its location within the active display area of the web page. In the simplest embodiment, the empty space is defined as a rectangular or square space that includes a usable area of the available unused space in a web page. For this type of boundary, the XY coordinates comprise the corner points of the boundary in terms of pixel locations. In other embodiments, the empty space can be defined by other two-dimensional shapes, such as circles, triangles, or compound polygons. For these embodiments, the coordinates of the boundary encompassing the clear space can be defined in terms of pixel locations or area and location formulae appropriate for the outline shape of the boundary.

The clear space display process can be configured to analyze one side adjacent the border of the screen and then the other. The process then analyzes successive areas closer to the center of the display. For example, the process may first analyze the right portion of the screen and then move to the left, top, and bottom portions of the screen as defined by an area, such as a one inch margin around the edge of the display. If no clear space is found, the process moves successively inward to close in on the center of the area. This process takes advantage of the fact that most content occupies the center portion of the screen and that most unused space is available around the sides of the display area.

Generation and Display of Intermediate Messages

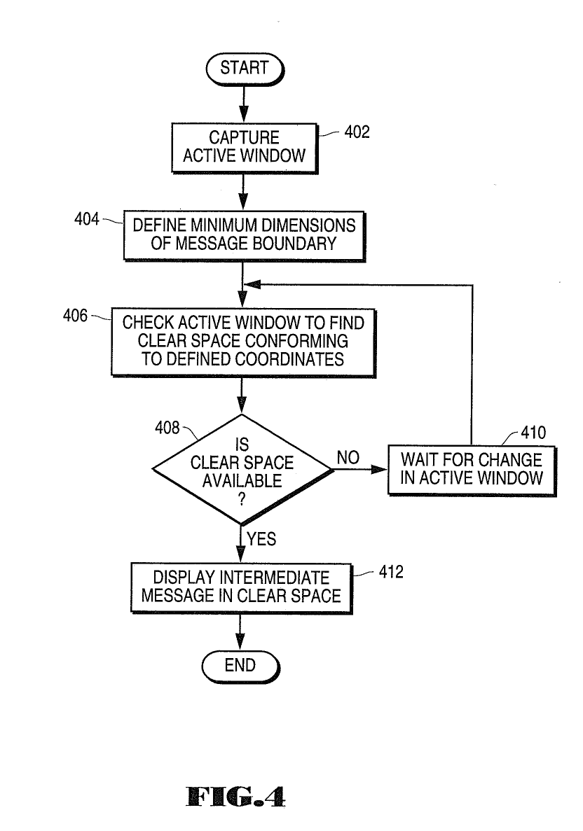

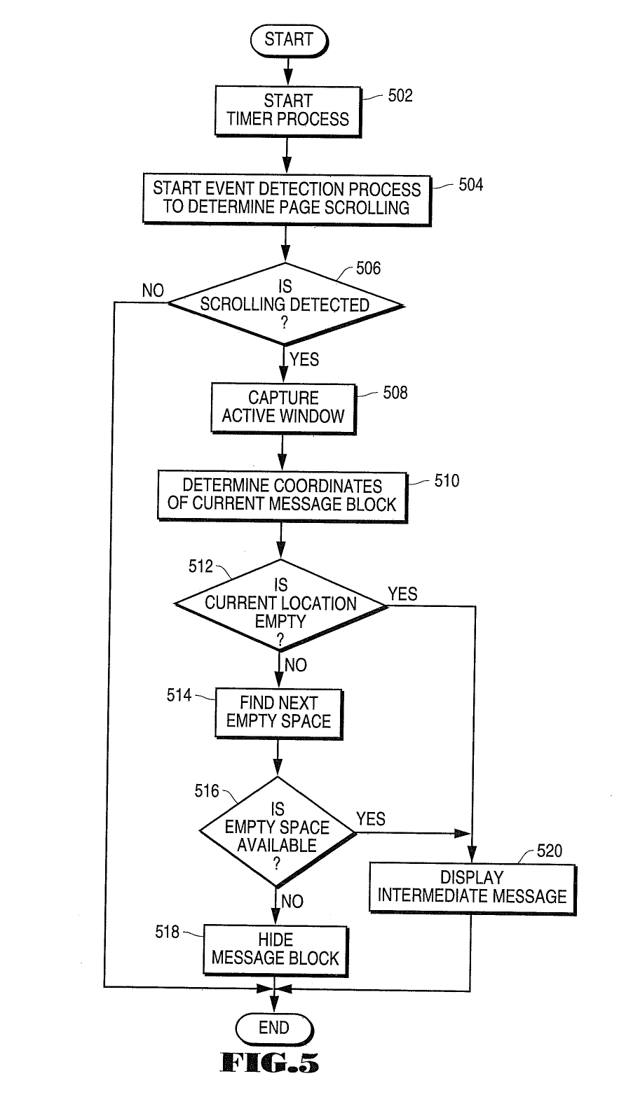

FIG. 4 is a flowchart that illustrates the process of identifying and displaying intermediate messages in the clear space of a displayed web page, according to one embodiment of the present invention. In step 402, the active window in which the intermediate display image is to be displayed is determined. In computer applications, a computer desktop can include various simultaneously open windows, such as a word processor program, e-mail program and web browser all running concurrently. Typically only one application can be active at one time, with the other applications displayed in the background of the active window. For this embodiment, it is assumed that the intermediate message is to be displayed in the clear space of a web browser program. In step 402, the displayed web page of an active web browser program is displayed.

In step 404, the minimum size of the required clear space is defined. The size of the clear space boundary is defined in terms of dimensions that specify the size, shape of boundary in which the intermediate message is to be displayed. In some cases, an active web page may include several regions of unconnected unused space. A minimum clear space area is defined, such that clear space that is not of a sufficient size is not flagged as an identified clear space. In one embodiment, if two or more disparate areas of clear space are of sufficient size, all such areas may be flagged and defined within the active window as being available for the display of intermediate messages.

In step 406 the active window is scanned to find clear areas that conform to the minimum dimensions defined in step 404. Clear space comprises space in the active window that does not contain purposive content; such clear space could comprise plain white background, a constant color background, or a repeated pattern background (such as a static screensaver pattern). In one embodiment of the present invention, an RGB color code is defined for the clear space. The clear space display process 105 scans the active window and looks for groups of pixels of the defined dimensions that conform to the defined clear space color code. If such a grouping is found, this area is defined as clear space within the active window. If the active area includes a background pattern that is not a constant color, but is instead a background pattern, the RGB color code is defined in terms of the background pattern. In this case, the background pattern must have a repetitive element, since a random pattern is difficult to define. In one embodiment, the clear space display process scans the active area for an appropriately sized clear space by moving from one column (or row) of pixels to the next column (or row). Alternatively, the clear space display process analyzes a set of pre-defined pixels within the active area. If one or more pixels within the first set of analyzed pixels conform to the defined pattern, neighboring pixels are analyzed to determine if an appropriate clear space exists.

In step 408 of FIG. 4, it is determined whether an adequate clear space area exists within the active window. If a clear space area exists, an intermediate message is displayed in this area, step 412. In one embodiment, the intermediate message is downloaded from the intermediate message content storage location 127 in the client computer 102. For example, the intermediate message could be stored in a local cache for display by the clear space display process 105 upon the identification of a clear space area in the active window. This intermediate message is then displayed in the foreground of the active window within the predefined boundary location. If the intermediate message is not stored or generated locally within the client computer 102, it may be downloaded over the network from a remote source, such as content provider 103 or web server 116. If, in step 408, it is determined that clear space is not available within the active window, the clear space display process does not download and display the intermediate message. Instead, it waits for a change in the active window that may create the availability of clear space within the window, step 410. Such a change could be the reloading of another web page or the scrolling of a web page within the display area.

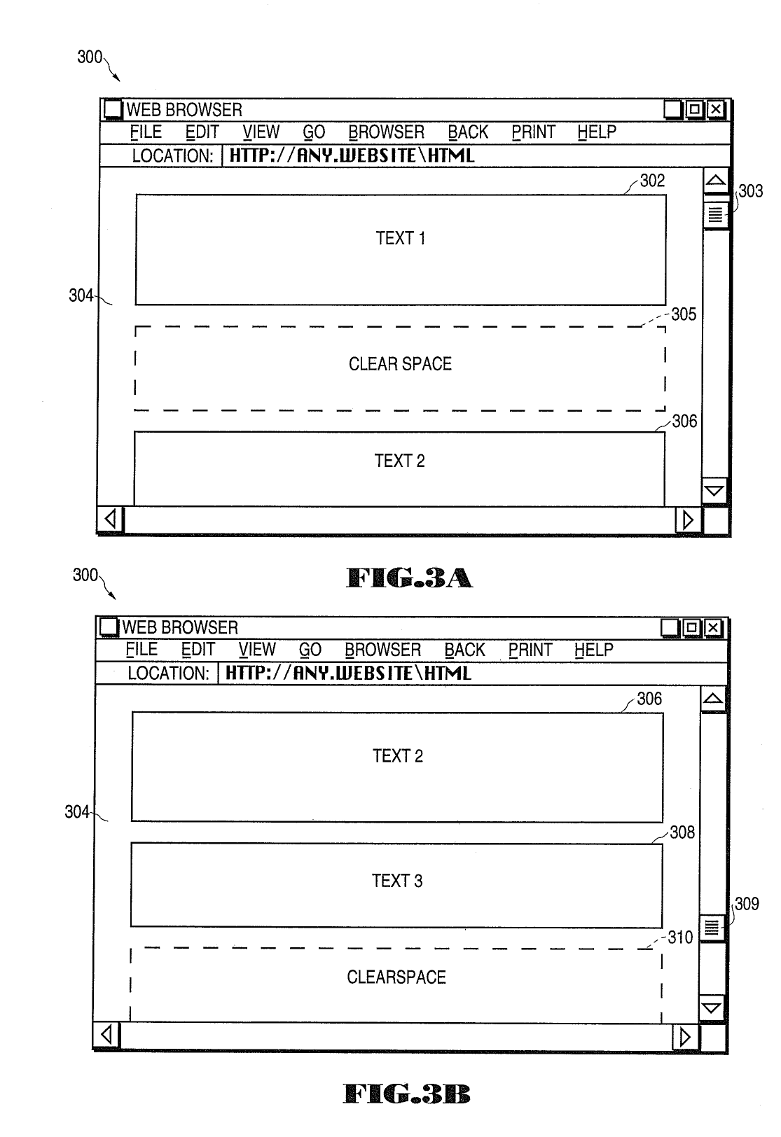

Some web pages may include content that cannot be displayed within the confines of a single display screen. These pages typically require that the user scroll through the web page to view the entire page. On most web browsers, this is accomplished using scroll bars 215 and 217. As a user scrolls up or down, or left or right through a web page, the contents of the web page shift in the display device. The empty space within the web page also shifts as the page is scrolled. FIGS. 3A and 3B illustrate the shifting of a web page display as the web page is scrolled from a first position to a second position. FIG. 3A illustrates an exemplary web page with a recognized clear space area in a first scrolled position. In web page 300 in FIG. 3A, the display area 304 corresponds to the page when the scroll bar is in a first position 303, and includes a first text display area 302 and a second text display area 306. An unused clear space 304 is available between these two text areas. FIG. 3B illustrates the exemplary web page of FIG. 3A in a second scrolled position, as indicated by the scroll bar in a lower position 305. For this display, the second text display area 306 has shifted up, and a new text area 308 has appeared. For this web page display, a new clear space 310 is available at the bottom of the page.

FIG. 5 is a flowchart that illustrates to process of displaying intermediate messages in the clear space of a scrolled web page, according to one embodiment of the present invention. In step 502 a timer process is started. The timer process periodically checks the active window to determine a change, and executes a find clear space process that scans the active window for clear spaces. In one embodiment, the active window is checked every two seconds to determine if an intermediate message can be displayed in a clear area. The timer period can be altered depending upon the requirements and configuration of the client computer system.

In step 504 an event detection process is started. This process captures the state of the active window and determines if a state change has occurred. For example, if the active window is an HTML web page, the event detection process determines if a new web page has been loaded, or an existing web page has been scrolled up or down, or left or right. In step 506 it is determined whether the displayed page has been scrolled or otherwise changed. In one embodiment, the process illustrated in FIG. 5 assumes that an intermediate message is either presently being displayed or that no clear space is available. For this embodiment, if in step 506, the displayed page is not scrolled, the process ends, with the intermediate message continuing to be displayed or hidden, depending on the current state. If, however, in step 506 it is determined that the page has been scrolled, the new active window is captured, step 508. In step 510, the coordinates of the currently defined message block are determined. The coordinates include the location of the message block on the page prior to the scroll operation, as well as the size and shape of the message block. It should be noted that this step assumes that an intermediate message was displayed in a clear space area in the page prior to the scroll operation. In step 512, it is determined whether the same location and dimensions in the new active window is empty and clear. If the location is clear, an intermediate message is displayed in the clear space. This results in the intermediate message being displayed in the same relative location of the new scrolled page. If it is determined in step 512 that the current location is not empty, a new empty space within the new active window is located, step 514. In one embodiment, this is accomplished by comparing groups of pixels within the active window to predefined RGB color patterns, or other predefined pixel patterns, as described in relation to the process illustrated by step 406 in FIG. 4. In step 516 it is determined whether an appropriate empty space within the new active window is available. If not, the intermediate message is hidden, step 518, and the process either ends or repeats from step 504 upon initiation by the timer process started in step 502. If an appropriate empty space is available in the new active window, the intermediate message is displayed in step 520. As described in reference to FIG. 4, the intermediate message could comprise text, graphic, video or other content provided by the client computer locally, or downloaded over the network from a remote content provider or server.

For the process illustrated in FIG. 5, a currently displayed message is relocated in a newly active window if clear space in the same relative or different location is available. The dimensions of the message boundary size are maintained if the same size area is available in the new window. In an alternative embodiment, the message boundary size may change if a larger or smaller amount of contiguous clear space is available in the new window. For example, if smaller area of clear space is available, the message boundary size may be scaled down to fit in the smaller clear space. Similarly, if a larger area is available, the boundary size may be scaled up to fit in the larger clear space. Moreover, the shape of the message boundary area may be altered to fit different shape clear spaces that may be available.

Embodiments of the present invention are intended to be used with any type of web browser or web server that has a principal display area associated therewith. In addition, embodiments of the present system may be used with other types of display programs and display devices. For example, the display device may be a television, and the intermediate message display process may be configured to find clear space within a static display or dynamic program being viewed on the television.

In one embodiment of the present invention, the client intermediate message display process 105 works with the web browser 114 to determine when and where to display the intermediate message as illustrated in FIG. 2. A typical example of an intermediate message might be an advertising message generated and provided by a product or advertiser content provider during the period of time that the user is waiting for a new web page to load. Because the Internet allows relatively easy access to literally a worldwide marketplace, web sites have become increasingly used by commercial entities as virtual “storefront” sites. Indeed, retail Internet sites allow customers to make shopping decisions and perform entire purchase transactions on-line without visiting a store or speaking to a clerk. One significant development in electronic commerce (“e-commerce”) sites is the integration of advertising messages with the server content. As in the magazine publishing industry, for example, such advertising is often used by the content provider to subsidize at least a portion of the cost of maintaining the web page and providing the products or data to the customer. Because of the ability to reach so many potential customers, advertisers often utilize different techniques to present their message through Internet sites. Pop-up advertising messages, banner ads, hidden links, and Java applets that are all embedded within a content provider's web page are all examples of some of the techniques used by advertisers to get their messages to the users. Embodiments of the present invention allow advertisers to effectively increase their exposure for their products or services.

In general, the intermediate message displayed by the clear space display process is displayed over of the unused area of the active web browser window so that the unused background space is essentially hidden in whole or in part by the intermediate message. The intermediate message display can be displayed in an HTML frame or display area that can display text, graphics, streaming video, or other type of data. Moreover, this intermediate message display area may include standard GUI elements that allow the message display window to be resized or scrolled within. In one embodiment, the appearance of the display message itself along with the size of the message may be tailored depending upon the nature of the clear space in which it is displayed. For example, it may be displayed as a translucent, rather than opaque object so that content underneath the message is still somewhat visible. In the case where the clear space comprises a unicolor display area, the intermediate message may be displayed in a contrasting or complementary color to allow the message to stand out or blend in with the underlying displayed content. For limited size display areas or crowded web pages, the intermediate message display area 212 may be relatively small. In this case, the intermediate message may comprise a series of sequential images, such as text, which are shown in quick succession to form an overall message.

As described above, the content of the message displayed in the intermediate message display window may be provided by the intermediate message content data 127 contained in local memory of the client (web browser) computer. This may be done by storing the intermediate message content data 127 in the client computer local memory, such as a cache memory, and uploading this data from the cache during web browser idle periods. For this embodiment, the intermediate message content data 127 may periodically be updated from the intermediate message content 108 provided by a content provider 103 or other computer, such as server 104. For systems in which the client computer 102 is a wireless device, such as a PDA, cellular phone, or similar device, the intermediate message content data can be provided on resident storage media, such as solid state disk, memory card, flash memory, or similar devices. Alternatively, the intermediate message content data 127 can be uploaded from a memory coupled to other computers on the network, such as content provider 103 or server 104. For this embodiment, the content data can be uploaded to the client computer off-line periodically from the server. 104 or content provider 103. The number of different messages and the frequency of updating the messages can be determined by the server or content provider. For example a series of ads can be sequentially uploaded to the client computer according to a particular ad campaign schedule. This ensures that the displayed messages are timely and appropriate. Such upload operations typically occur during off-line periods when the modem or client network interface is idle, such as when the user is viewing a loaded web page. In this case, the client-side clear space display process 105 and/or server-side clear space display process 112 automatically upload any new message content to the client computer.

The clear space display process may include a module that searches for all areas of empty or unicolor space and compiles a list of contiguous areas of any size or shape. These areas can then be ranked in terms of size and shape for purposes of determining suitable space or spaces for the display of intermediate messages. Different messages could then be targeted to different areas, or intermediate messages could be divided and displayed in different areas. For example, this process may compile a list of squares of 3″, 2″, and 1″, and rectangles of 2″×6″ and smaller, and so on.

The clear space display process may also include a message monitoring function that monitors the number of times that a message has been viewed or the age of a message has been viewed or that is scheduled to be viewed. In this case, new message can be uploaded to replace messages that have been viewed a set number of times or that are otherwise stale. For example, if it is determined that a particular advertisement has been displayed on ten successive scrolled web pages, a new ad can be uploaded during the idle period of the web browser instance, so that the next time the taskbar is idle, a new ad is viewed. The upload mechanism may have an interrupt feature built-in so that if a context switch event occurs during the uploading process, the old advertisement is re-displayed. Besides pop up or banner ads, the intermediate message content displayed by the clear space display process could include other types of data. This includes, streaming data, hypertext links, stock quotes, graphic content, audio data links, or any data or information deemed useful in the course of using a computer, surfing the Web, watching television or using handheld devices, such as PDAs and cellular phones.

In one embodiment, the intermediate message that is displayed in the clear space or other defined area of the web page may be a widget, rather than a text message or graphic/video object. A widget is an interface element that a computer user interacts with, such as a window or text box. Generally a widget displays information or provides a specific way for a user to interact with the operating system and/or application. Examples of widgets include icons, pull-down menus, buttons, selection boxes, progress indicators, on-off checkmarks, scroll bars, windows, window edges, toggle buttons, forms, and any other mechanism for displaying information and for inviting, accepting, and responding to user actions. Widgets can also include interactive display areas that constantly display updated information that is available over the network. In this case, a widget may be a lightweight application that resides on the client computer and fetches information when the client is online. For this embodiment, clear space display area 212 of FIG. 2 comprises a window that is located in an unused region of display area 204. Any suitable widget may then be provided within this display area 212.

In one embodiment, the widget displayed in display area 212 may comprise a window to a remote desktop on a computer or computing device operated by user of client 102. It may then include a user interface that allows the transfer of files from the remote device to the client computer.

Automatic Taskbar Overlay Message Display Process

As shown in FIG. 2, a web page typically has a graphic user interface (GUI) that allows a user to control the web browser functions through a mouse and keyboard by pointing and clicking various control buttons that access and invoke various commands. The control buttons are typically provided in a dedicated area of the web browser, usually referred to as the “taskbar” or “toolbar” 202 of the web browser. By using the cursor to operate the functional buttons or pull down menus of the web browser taskbar the user is able to control the displayed information from computers on the Internet. The taskbar also usually contains an area into which the user can type in an address called a URL (“Uniform Resource Locator”) to obtain a desired HTML document or view a particular web page.

In one embodiment, the client intermediate message display process 105 serves to generate and display automatic taskbar overlay messages, such as pop-up advertisements or other intermediate message, while the taskbar controls are idle and unused. A user may access the taskbar commands to input a web page URL or access the navigation buttons. When the user is viewing a downloaded web page, however, this taskbar area is idle and unused. A timer and display process is used to determine that the taskbar is idle when the cursor has been positioned within the web page area of the browser window, or the cursor has not been moved or clicked for a certain period of time while in the taskbar area and the keyboard controlled browser taskbar functions have not been actuated. When the system senses that the taskbar is idle, an intermediate message is displayed over the taskbar area of the web browser with a customized display message.

Embodiments of the present invention are intended to be used with any type of web browser or web server that has a taskbar area associated therewith. Embodiments of the present system first determine if the web browser program is active, the system then determines the area size and location of the taskbar. If the taskbar controls are idle the system displays an intermediate message over the taskbar. There are several conditions that indicate whether the taskbar is idle and the intermediate message can be displayed. These include whether the cursor is placed in the main display area of the web browser, whether the cursor has remained stationary in the taskbar area; whether the cursor has been actuated in the taskbar area; or whether the keyboard operated taskbar functions have not been actuated for a certain period of time, among other conditions. When the system detects specific combinations of these conditions the automatic taskbar overlay function is executed and an intermediate message is displayed over the taskbar area of the web browser.

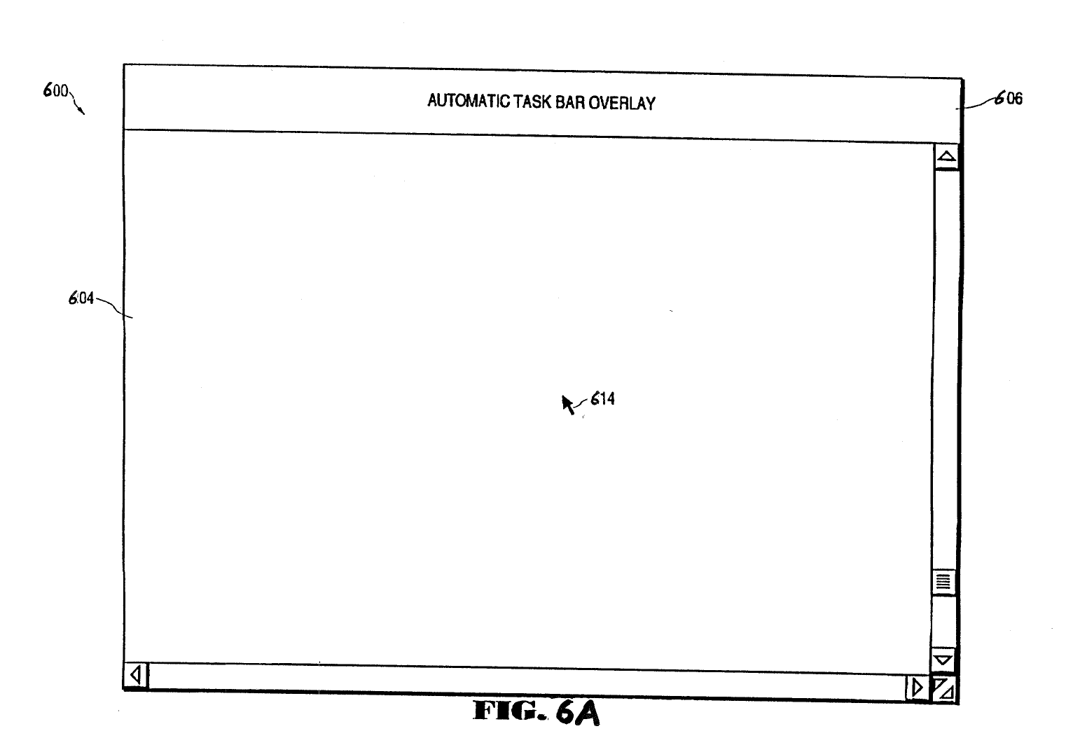

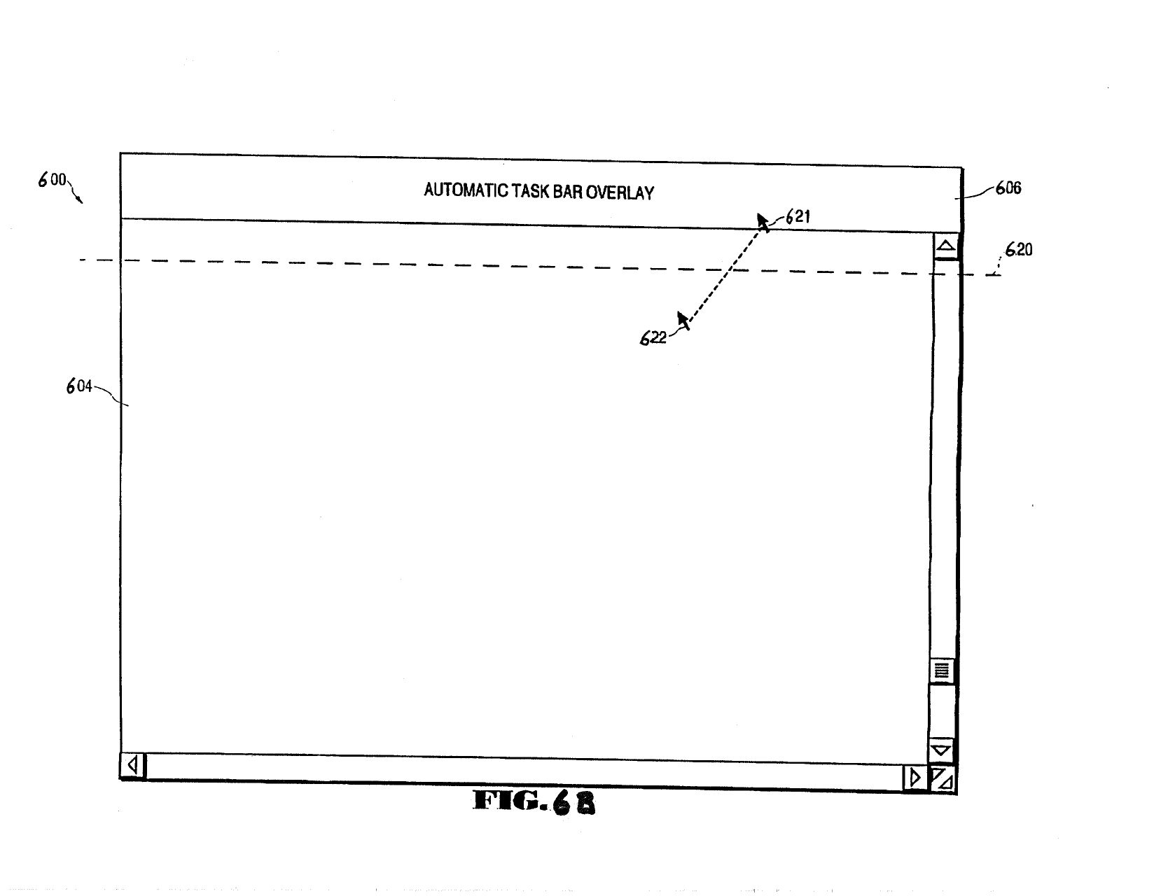

A user typically only accesses the taskbar area 202 of a web browser program when he or she desires to navigate around web sites or perform some function, such as print a web page, perform a search, and so on. At most other times, such as when a web page is being viewed, the taskbar area 202 is unused. Moreover, this area does not form any part of the content of the displayed web page. It is simply provided as part of the web browser as a convenient area to access program command menus and for the display of commonly used commands. During this idle time, the taskbar area 202 essentially constitutes wasted space in the web browser display 200. In one embodiment of the present invention, an intermediate message is generated and displayed over the taskbar area 202 when the taskbar is unused and idle. FIG. 6A illustrates a web browser window 604 on a client computer, such as network client 102 in FIG. 1, in which an automatic taskbar overlay (ATO) 606 is generated and displayed over the taskbar area of the web browser. The automatic taskbar overlay comprises a dedicated display area that can be used to display an intermediate message. According to one embodiment of the present invention, the client intermediate display process 105 has determined that the taskbar controls are idle because the cursor 614 has been placed in the web page 604 region of the browser window 604 and the keyboard controlled browser actions have not been actuated for a certain period of time.

In one embodiment of the present invention, the automatic taskbar overlay process is activated when the cursor 614 is moved from the taskbar 606 into the web display area 604. FIG. 6B illustrates the movement of the cursor from a first position 621 from the taskbar 606 to a second position 622 within the web display area 604. The intermediate message display process 105 defines a threshold line 220 in relation to the taskbar area 206. When the cursor moves past the threshold area defined by line 220 in the direction from the taskbar into the web display area, typically a downward direction, the automatic taskbar overlay process is activated. At this point, an intermediate display message is displayed over the taskbar 206, since it is assumed that the user no longer needs access or viewing of the taskbar 206.

Conversely, when an intermediate message is displayed in the taskbar area of the web browser, the automatic taskbar overlay process can be suspended to return display of the taskbar when the cursor is moved back over the taskbar. In this case, it is assumed that the user requires access to the taskbar, so the intermediate message is hidden to reveal the taskbar. In this case, with reference to FIG. 6B, if the cursor is in a first position 622 in the web page display area 604 and is moved to a second position 621 over the taskbar 606, and crosses over the pre-defined threshold 620, the intermediate display message is hidden and the taskbar is shown. As illustrated in FIG. 6B, in one embodiment of the present invention, the intermediate display is displayed or hidden depending upon the position of the cursor relative to a display area demarcation line 620. This line is positioned relative to the taskbar, and can be placed anywhere within the web browser display 600 in the vicinity of the taskbar 606. Generally, it will be placed on or near the border of the taskbar 606 that is adjacent to the web display area 604. Thus, in FIG. 6B, line 620 is placed near the bottom edge of taskbar 606. Placing the demarcation line 620 on or near the taskbar generally speeds the display of the intermediate message when the cursor is moved from the taskbar into the web display area. Conversely, placing the demarcation line 620 further away from the taskbar 606 speeds the re-display of the taskbar when the cursor is moved from the web display area to the taskbar area.

In one embodiment of the present invention, the automatic taskbar overlay process is activated depending upon the movement or activity of the cursor, as well as its position relative to the taskbar. If the cursor is stationary or inactive for a pre-defined period of time, it is assumed that the taskbar functions are not needed or being viewed. In this case, the automatic taskbar overlay process will cause an intermediate message to be displayed over the taskbar 606. For example, in FIG. 6B, if the cursor is in either position 621 or 622, and the cursor and keyboard controlled browser functions have been idle for a preset period of time the automatic taskbar overlay 606 will be activated. In this embodiment, the system monitors the motion and button actuation of the cursor while it is in the web page display area 604 or taskbar area 606. If it is determined that there is an idle taskbar period because the cursor 614 has been stationary and the keyboard controlled browser functions have not been actuated for a preset period of time, and intermediate display message is shown.

The automatic taskbar overlay is immediately hidden or removed from the browser window 604 when the system detects that the taskbar is being used. There are several actions that indicate that the taskbar is being used: the cursor is moved into the taskbar area; the keyboard operated taskbar functions are actuated; and a mouse button is actuated while the cursor is in the taskbar area. In one embodiment, if any of these actions are detected by the system, the automatic taskbar overlay 606 will be removed and the taskbar 602 will be displayed.

For the embodiment illustrated in FIGS. 6A and 6B the taskbar overlay message window 606 is displayed over of the taskbar window 604 of browser window 604 so that the taskbar is essentially hidden in whole or in part by the intermediate message. The automatic taskbar overlay 606 can be any type of display area that can display text, graphics, streaming video, or other type of data. The automatic taskbar overlay 606 can be of a standard size, or it may include standard GUI elements that allow the message display window to be resized or scrolled within. The size and location of the automatic taskbar overlay 606 can be programmed by the server to be displayed in any appropriate manner over the entire taskbar or over a portion of the taskbar. Because the user may be primarily interested in the content of the web page, the user is typically not concerned with an automatic taskbar overlay that is displayed over the idle taskbar window.

There are several parameters that control the generation and display of a taskbar overlay message. For example, certain rules must be defined and processed that govern the detection of idle taskbar controls that causes the automatic taskbar overlay to be displayed, and rules must be defined and processed that govern the transmission, display, and hiding of the automatic taskbar overlay message. The automatic taskbar overlay message display program generally performs three main tasks in the generation and display of the automatic taskbar overlay message. The client intermediate message display process first gets intermediate message data from a storage file. This can be accomplished by, for example, uploading intermediate message content from cache memory or from a local or remote memory location. The process then checks if a client web browser window is open. If the browser window is not open, the program opens the browser window and the automatic taskbar overlay window, and if it is open, the automatic taskbar overlay process is started. When the browser application stops, the automatic taskbar overlay process also ceases.

In one embodiment of the present invention, the taskbar overlay process monitors both the position of the cursor and the idle time of the cursor. For this embodiment, the automatic taskbar overlay defines a demarcation line on the web browser display area, and includes a timer routine that monitors the period of inactivity or use of the cursor. The time routine records the elapsed time that the cursor or taskbar controls have been idle. For example, if the cursor in the taskbar area is idle, the period of time that the mouse buttons have not been actuated, and the keyboard controlled taskbar functions have been idle is monitored. If the cursor or taskbar controls have been idle for a preset period of time, the system displays the automatic taskbar overlay. In one embodiment, idle time period is a fixed parameter, such as one second or five seconds that is programmed into the automatic taskbar overlay process, and is inaccessible to the user. Alternatively, the automatic taskbar overlay process may include a routine that allows the idle time period to be adjusted by the user.

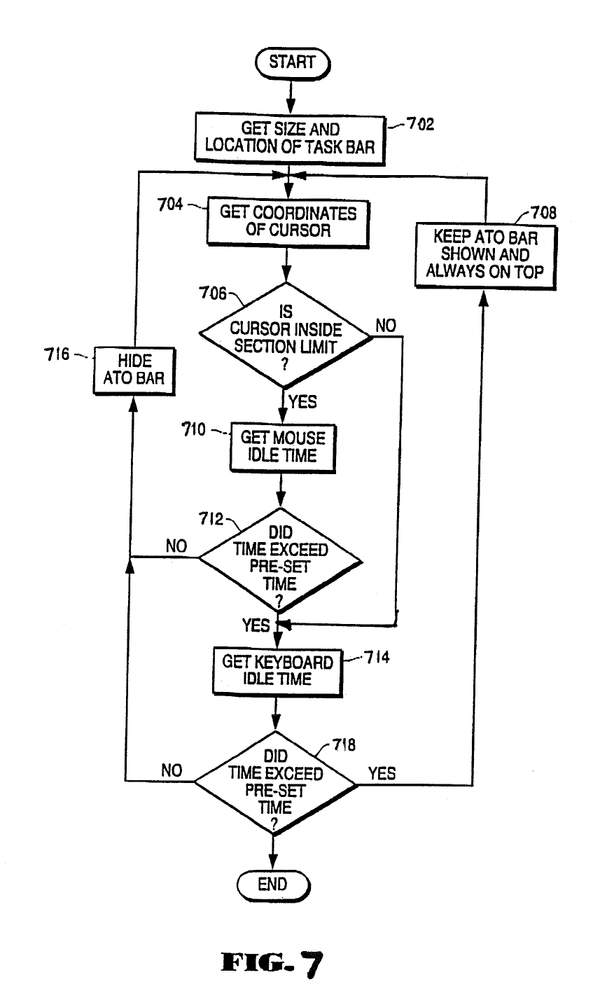

FIG. 7 is a flowchart that illustrates the process of displaying an intermediate message in an automatic taskbar overlay by monitoring the activity of the taskbar controls and the position of the cursor, according to an embodiment. In step 702, the system determines the size and the location of the browser taskbar. Some web browser and computer GUI programs allow the web browser display area and taskbar to be moved or resized within the monitor display area. If the taskbar has been moved or resized the program determines the new size and location of the browser taskbar. The program uses the browser taskbar size and location information to properly size and place the automatic taskbar overlay over the taskbar when the taskbar controls are idle. The program then obtains the coordinates of the cursor 704 and determines if the cursor is inside the section limits, step 706. The section limits are defined by the demarcation line 620 defined by the automatic taskbar overlay process in the web browser display area. Note that one demarcation line can be defined to activate the automatic taskbar overlay and another can be used to hide the automatic taskbar overlay, or the same, in which case there are two section limits, one to hide and one to activate the intermediate message. Alternatively, one demarcation line can be used to both hide and reveal the intermediate message, in which case there is one section limit for the automatic taskbar overlay process.

If the cursor is outside the section limits of the taskbar, and is within the web page display area, the program proceeds to step 714. If the cursor is inside the section limits of the taskbar the program then determines the time that the cursor and mouse buttons have been idle, step 710. In step 712 it is determined whether the idle time for the cursor exceeds the pre-set time period (for example 5 seconds). If the cursor or mouse buttons have been active within the preset time period, the automatic taskbar overlay is hidden and the taskbar is displayed, step 716. If the cursor and mouse buttons have been idle for longer than the preset time period 712, or if the cursor has been set outside the taskbar area section limit, as determined in step 706, the idle time of the keyboard actuated browser functions is determined, step 714. If the idle time of the keyboard actuated browser functions exceeds a preset keyboard control idle time, as determined in step 718, the automatic taskbar overlay is displayed, step 708. If the keyboard control idle time has not been exceeded the automatic taskbar overlay remains hidden 716 until the preset time is exceeded.

As illustrated in the process of FIG. 7, there is a preset time for the cursor to be idle within the taskbar area or browser display area, and a preset time for the keyboard actuated browser functions to be idle. These preset times may be the same or different depending upon the desired configuration of the system.

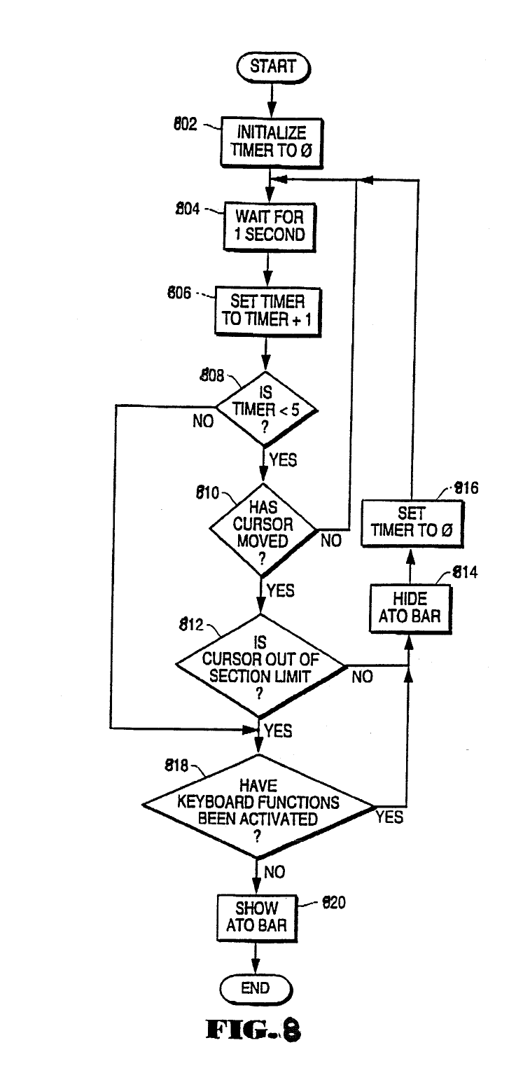

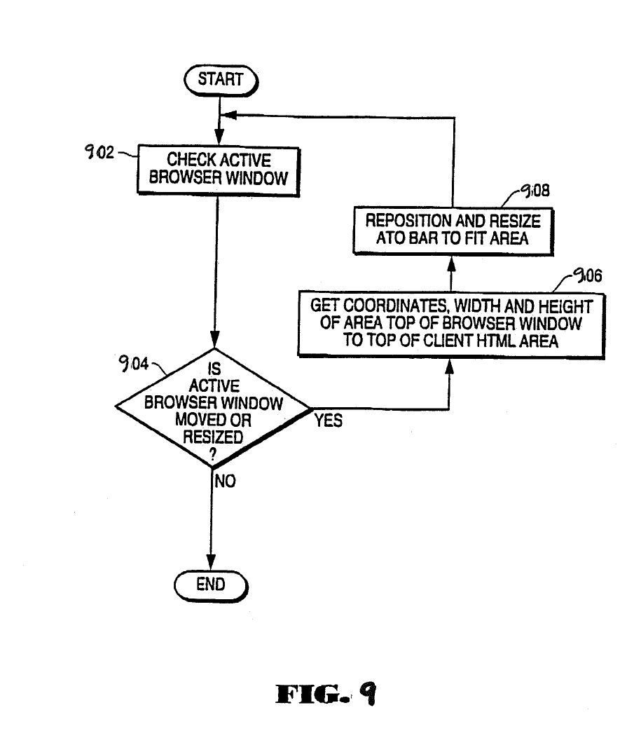

A more detailed description of how the automatic taskbar overlay process monitors the idle time of the cursor is described in the flowchart of FIG. 8. In step 802, the automatic taskbar overlay process initializes or reset the timer to zero. The system waits for one second, step 804, and then sets to the timer to prior time +1 second, step 806. The timer is checked to determine if the elapsed time is less than a preset time 808. For the example illustrated in FIG. 8, the preset time is five seconds. If the timer count is greater than five seconds, as determined in step 808, the system displays the automatic taskbar overlay, step 820 after determining that the keyboard functions have not been activated, step 818.

If, in step 808, it is determined that the cursor idle time is less than 5 seconds, the system checks for cursor movement, step 810. If the cursor has not moved, the elapsed time continues to run and the system continues to monitor the timer from step 808. If the cursor has been moved, the system checks the position of the cursor relative to the section limit that defines the display of the automatic taskbar overlay, step 812. If the cursor is outside of the taskbar area of the display or section limit, the system checks the keyboard browser function, step 818. If the keyboard browser functions have not been activated, the automatic taskbar overlay is displayed, step 820. If the cursor has moved and been positioned over the taskbar, the system hides the automatic taskbar overlay, step 814. This allows the taskbar to be seen by the user. The timer is then reset to zero, step 816. Similarly, if the keyboard browser functions have been activated as determined in step 818, the system hides the automatic taskbar overlay, step 814 and the timer is reset to zero, step 816. After the timer is reset to zero, the system resumes monitoring the timer, cursor movement, and keyboard controls.

In the embodiment of the present invention illustrated in FIG. 8, there are two conditions under which the automatic taskbar overlay is displayed: one, the cursor has not moved for more than five seconds and the keyboard browser functions have not been actuated; and two, the cursor has moved in less than five seconds, but the cursor is not over the taskbar and the keyboard browser functions have not been actuated. Note that there are other conditions that can be defined that dictate the display or hiding the automatic taskbar overlay. For example, cursors are frequently controlled by a pointing device, such as a mouse, joystick, trackball, and so on. These pointing devices frequently utilize a button to click on embedded functional areas of a graphic user interface. The clicking of a cursor placed over the taskbar area of the display may similarly result in the hiding of the intermediate message within the automatic taskbar overlay. Further the preset idle period before the automatic taskbar overlay is displayed can be variable and may typically be anywhere between one second to ten seconds.

To properly define the automatic taskbar overlay area, the automatic taskbar overlay process first determines the size and location of the taskbar, as illustrated in step 702 of FIG. 7. The taskbar size and location step is illustrated in more detail in the flowchart of FIG. 9. In step 902, the automatic taskbar overlay process determines if an active browser window is open. The process then determines if the browser window has been moved or resized, step 904. If the browser window has not been moved or resized the automatic taskbar overlay is not adjusted and the system continues to monitor the browser window activity. If the browser window has been moved or resized, the coordinates of the browser window, and the width and height of the taskbar area of the browser window are determined, step 906. The automatic taskbar overlay is then resized and positioned to match the size and position of the taskbar so that when the overlay is displayed it will cover the taskbar, step 908. In one embodiment, the automatic taskbar overlay is sized so that it covers the entire taskbar area. Alternatively, the automatic taskbar overlay can be sized so that it covers only a portion of the taskbar and leaves some area, such as perhaps the URL address line of the taskbar open. In either embodiment, the automatic taskbar overlay does not cover any area of the web browser display area 204.

In general, the ATO overlay process is triggered by the position of the cursor during a pre-defined period of time and relative to an area defined around or in the vicinity of the taskbar. Thus, in general, it is first determined whether or not the cursor is outside the section limit. As illustrated in FIG. 6B, the section limit 620 defines a border relative to the taskbar. If the cursor is outside the section limit, a cursor timer process is started. In one embodiment, the cursor timer corresponds to the timer initialized and incremented in the flowchart of FIG. 8. It is possible to have multiple browsers open on a client computer simultaneously. In a typical window-based graphical user interface environment, only one browser will be active at any time and the cursor will only operate the current active browser. However, if two or more web browser windows is open, the automatic taskbar overlay process can be programmed to display the intermediate message in the taskbar area of the inactive browser window). In an alternative embodiment, the automatic taskbar overlay is only placed over the taskbar of the active browser. If the web browser is reactivated, the system waits for a condition under which the taskbar is inactive before displaying the automatic taskbar overlay.

The intermediate message displayed in the automatic taskbar overlay may be a static message, or it may be a message that is dynamic and changed periodically. It may also be a widget or similar graphical user interface element. The system may time the duration that each intermediate message is displayed and change the message after each message has been displayed for a specific period of time. Additionally, the intermediate message may be changed every time the taskbar is reactivated or in combination with a specific elapsed time.

In one embodiment, to maintain the integrity and normal operation of the client web browser program, the intermediate message displayed in the automatic taskbar overlay is normally not allowed to add any processing overhead or additional latency to standard web browser functions. For example, the display of an intermediate message does not slow down the web browser so that a new web page loads more slowly. In general, the automatic taskbar overlay process is not allowed to create its own delays to display the intermediate message.

Context Switch Intermediate Message Display Process

In one embodiment of the present invention, the client intermediate display process 105 is configured to generate and display intermediate messages, such as pop-up advertisements, during the idle time of a context switch in a web browser program. Throughout the following description, the term “context switch event” is used to refer to any client or server executed process that causes the web browser program running on the client computer to switch from one task to another. The most common example is when a web browser switches from one displayed web page to another web page through the invoking of a hyperlink icon or keyboard command. For example, a user may switch from a web page at a first URL (Uniform Resource Locator) address of “http://abc.com/index.html” to a second URI, address of “http://xyz.com/index.html”. This is typically accomplished by typing the second URL address in the location or address location in the web browser, or accessing a hyperlink in the first web page, if one is available. Such a web page change triggers a context switch event for the web browser. Another example of a context switch might be the launching of an applet or other such program in the display window if a web browser program. A further example would be when a user scrolls from a first page to a second page within the same URL. It is assumed that during the switching of the events, there is a certain delay ranging from fractions of a second to tens of seconds. This delay is typically caused by a URL redirect operation within the web browser, as the web browser accesses the memory location storing the new page, program, or data requested by the user.

Embodiments of the present invention are intended to be used with any type of web browser or web server context switching event that has a potential delay associated with it. As shown in FIG. 2 a web browser display on a client computer can include several intermediate display windows that are generated or sourced from one or more server or content provider computers to client 102. In the web browser display 200 of FIG. 2, a context switch may be invoked to display a sub-window such as area 208 or 210, such as a switch from one web page to another web page. Alternatively, an entire new web page may replace a previously displayed page. Throughout this description, the display of a web page may be referred to as a “browser instance”, and the period of the context switch may be referred to as the browser instance being “busy”. During a context switch, the display screen of the browser is typically frozen and input to the computer is disabled due to a masking of device-level interrupts by the processor. During this context switch delay, the client computer is typically idle.

During a web page loading sequence, the web browser typically receives a URL redirect interrupt, and in response, accesses the URL of the new page. Once the new site is found, the web page data is downloaded, and the new web page is displayed once the data is downloaded. The period of time between the “site found” event and the page load completion is the context switch time in which the browser instance is busy. Most web browser programs include display areas that indicate the display status of web pages, such as a display area that shows the percentage of the page loaded (e.g., “50% loaded”) and the status of the new web page. For example the display area may sequentially display the messages “web site found”, “loading”, and “done”, as the new web page is downloaded and displayed, as well as a graphical or numerical update of the percentage of the page loaded.

In one embodiment of the present invention, this idle period during which the browser instance is busy is utilized by the intermediate message display process 105 illustrated in FIG. 1. A typical example of an intermediate display might be an advertising message generated and provided by a product or advertiser content provider during the period of time that the user is waiting for a new web page to load. In one embodiment, an advertiser message window is displayed on the main display window of the web page. The message display window can be any type of display area that can display text, graphics, streaming video, or other type of data. The message display window can be of a standard size, or it may include standard GUI elements that allow the message display window to be resized or scrolled within. The size and location of the message display window can be programmed by the server to be displayed in any appropriate manner. The duration of the display depends upon the delay associated with the context switch event and is generally calculated by a process that will be described in greater detail below. Because the display within the main display area during a switch between two web pages or any similar event switch is typically a blank screen or old page, the user is typically not concerned with a message window or sub-window that is displayed over the idle display window or a portion of the window.

In one embodiment of the present invention, the content of the message displayed in the intermediate message display window 212 is provided by the intermediate message content data 127 contained in local memory of the client (web browser) computer. Because the idle time between a web page switch is typically quite short, on the order of seconds, the intermediate message data must be quickly transmitted to the client computer. This is most effectively done by storing the message data in the client computer local memory, such as a cache memory, and uploading this data from the cache during the context switching period. For this embodiment, the message data may periodically be updated from the intermediate message content 108 provided by a content provider 103 or other computer, such as server 104. For systems in which the client computer 102 is a wireless device, such as a PDA, cellular phone, or similar device, the intermediate content data can be provided on resident storage media, such as solid state disk, memory card, flash memory, or similar devices. In an alternative embodiment, during the context switching period, the message data can be uploaded from a memory coupled to other computers on the network, such as content provider 103 or server 104. However, because of the time required to upload the content data over a network, such an embodiment is most useful for situations in which the context switching time is known to be relatively long.

As described above, in one embodiment of the present invention, the data comprising the message content is transmitted to a local memory or cache memory on the client computer for display during the context switching period. For this embodiment, the content data can be uploaded to the client computer off-line periodically from the server 104 or content provider 103. The number of different messages and the frequency of updating the messages can be determined by the server or content provider. For example a series of ads can be sequentially uploaded to the client computer according to a particular ad campaign schedule. This ensures that the displayed messages are timely and appropriate. Such upload operations typically occur during off-line periods when the modem or client network interface is idle, such as when the user is viewing a loaded web page. In this case, the client intermediate display process 105 and/or server intermediate display process 112 automatically upload any new message content to the client computer. The upload mechanism may have an interrupt feature built-in so that if a context switch event occurs during the uploading process, the old advertisement is re-displayed.

In one embodiment, the intermediate message displayed during a context switch event can be displayed in a found clear space area. Alternatively, the intermediate message can be expanded to occupy the entire, or a significant portion of the display screen.

There are several parameters that control the generation and display of an intermediate message during a context switch event. For example, certain rules must be defined and processed that govern the triggering event that causes the display of the message, and rules must be defined and processed that govern the transmission, display, and hiding of the message. The intermediate message display program generally performs three main tasks in the generation and display of the intermediate message. The main steps of such a process include first identifying a triggering event. Such an event is an event or interruption that causes the user web browser to be idle for a certain period of time, and can be a user driven event, such as the user switching web pages, or a network caused context switch. The program next generates and transmits the intermediate message or data to the user web browser for display within a window 212 within the main display area 204 of the web browser. The generated message is then displayed for a specified period of time that is related to the browser idle time caused by the delay associated with the context switch event.

The intermediate message display process maintains several different parameters for determining when and how the display of an intermediate message is appropriate. For the embodiment of the invention in which the triggering event is a web page switch initiated by either the user or network, certain rules govern the determination of the triggering event, the display of the message and the hiding of the message. In one embodiment, several factors are included as part of the rules governing the display of the intermediate message. The first rule includes determining whether the browser instance is active. A browser instance is active when a particular page is active, and presumably, being viewed by a user. During a context switch, the browser instance may become busy. During this period, browser processing is idle and the display is generally frozen for the busy period. For the display of a new web page, the idle period encompasses the delay or latency time in which the new web page (new browser instance) is not fully loaded. A rule governing the display of the intermediate web page may be expressed as causing the display of a message while the new browser instance is incomplete by a certain percentage. For example, an advertising message may be displayed while the new page is less than 60 percent loaded.

In one embodiment of the present invention, the intermediate message display process includes a timer routine that records the elapsed time for the display of the intermediate message. The user can set the minimum duration of the message display (e.g., the minimum time that the advertisement is displayed after a context switch event), as well as the maximum duration of the message display. The display of the intermediate message is controlled by the duration of the browser instance (context switch) and the time set for the display of the message. If the browser instance is does not occur for a long enough period of time, the message is not displayed. Similarly, if the minimum display time set for the display of a message exceeds the duration of the browser instance, the message is not displayed. The message is only displayed in those occasions in which the browser instance is long enough in duration to meet the limits set for by the timer.

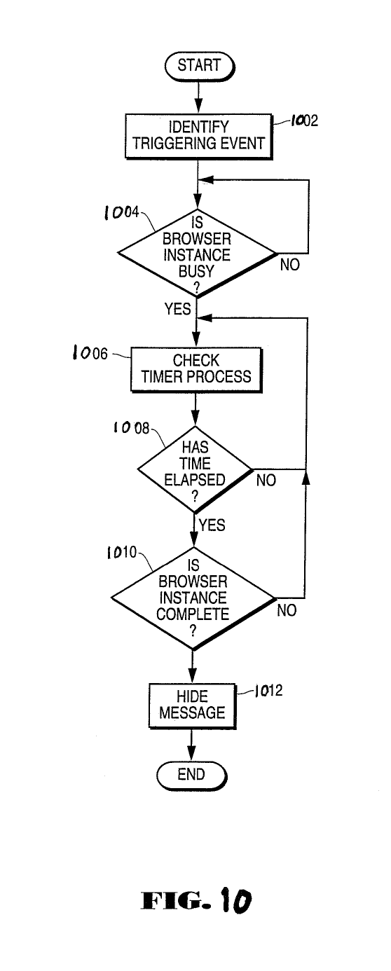

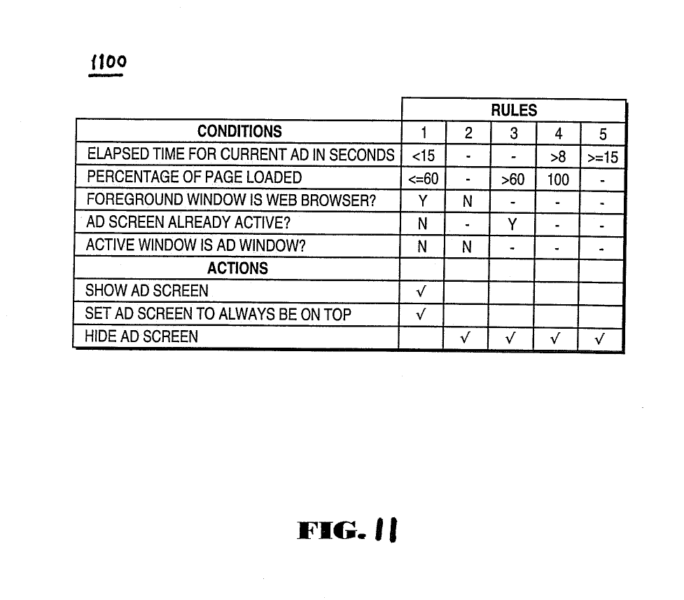

FIG. 10 is a flowchart that illustrates the process of displaying an intermediate message using rules that govern the duration of the browser instance and timer variables, according to an embodiment. In step 1002, the intermediate message display process checks for the occurrence of a triggering event. The triggering event is an event that causes the browser instance to switch context and become busy. In step 1004, the process checks whether the browser instance is busy. If so, the timer process that governs the duration of the displayed message is checked with regard to minimum and maximum display times, step 1006. If the minimum display duration time is acceptable, the message is transmitted and displayed on the client web site. In 1008 it is determined whether the maximum time has elapsed. It is also determined whether the browser instance has completed or is still busy, step 1010. If the message display duration has not exceeded the specified maximum time, and the browser instance is still sufficiently busy, the message remains displayed. Upon the occurrence of either the completion of the browser instance or the elapsing of the maximum time, the message is hidden, step 1012.

As illustrated in FIG. 10, there are several factors that can cause termination of the intermediate display. One factor is the maximum set display time. Another such factor is the completion or percentage completion of the browser instance. For example, if the new web page is 60% loaded, the message may be terminated. These two factors can also be used to generate certain rules that govern termination of the displayed intermediate message.

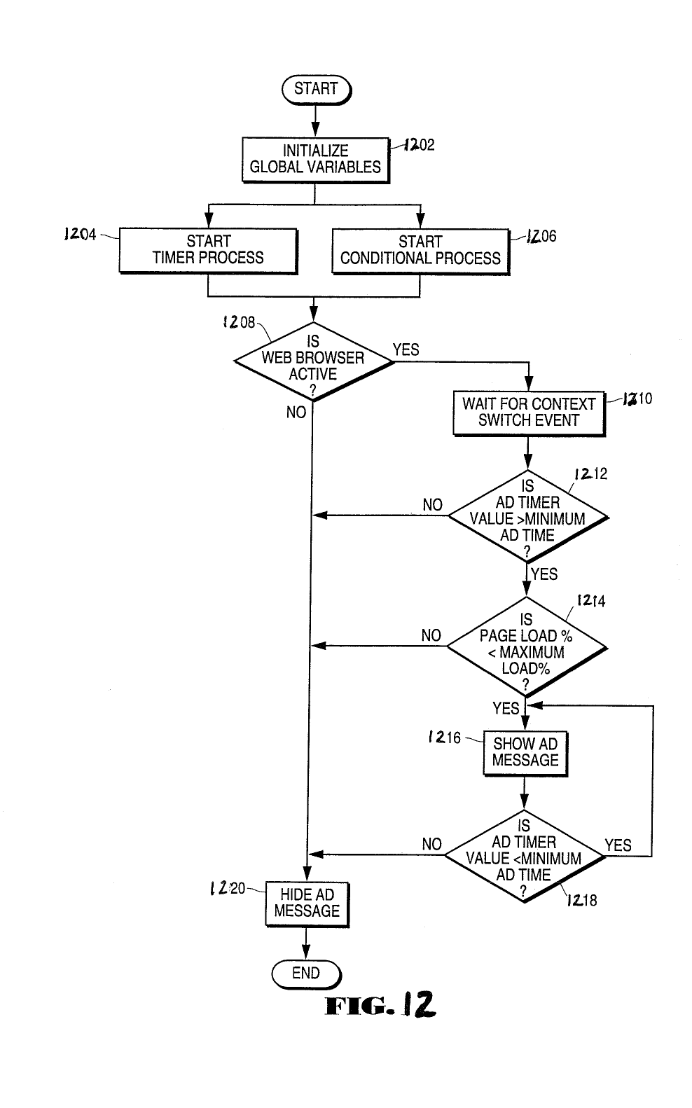

FIG. 11 is a decision table that illustrates the conditions and rules governing the display of an intermediate message in a client web browser, according to an embodiment. FIG. 11 is a table that illustrates the generation of five different rules that govern the display of an intermediate message in light of various conditions and actions. In general, the actions include showing the message (ad) screen, setting the ad screen as a front-most display screen, and hiding the ad screen. The conditions include the elapsed time for the display of the ad, the percentage of the new page loaded, and the status of the ad screen and active screen. Depending upon the quantitative or binary value of the conditions, the particular action to be taken is dictated by the five rules illustrated in Table 1100. For the embodiment illustrated in FIG. 11, certain conditions expressed and processed as binary values of yes or no, such as whether the ad screen is already active. Other conditions may be expressed as percentage or quantitative values, such as percentage of a new page that is loaded, or the elapsed time of the intermediate message display in seconds. In one embodiment, the intermediate message display process maintains a rule processing program that stores the program variables and determines the action to be taken in accordance with the specified variables and conditions for the triggering event.

FIG. 12 is a flowchart that illustrates the operation of the client intermediate message display process, according to an embodiment. In step 1202 certain global variables used by the process are declared. Such variables include: an error flag to trap any errors and handle them; an ad flag to denote whether the ad screen is active (True) or inactive (False); a minimum ad time variable to set the minimum time for the ad to be allowed to retract, a maximum ad time to set the maximum elapsed time the ad screen is allowed to remain shown; a maximum percentage variable that sets the maximum percentage (e.g., 60%) of loading for a new web page that is allowed until the ad is retracted; and a load percentage variable that sets the active foreground web page progress value. After the global variables are defined, the program will begin to execute two other predefined processes. These processes include a timer process 1204 that comprises an ad timer process and an evaluation timer process. These two timers are executed periodically, such as once every 50 milliseconds, and perform tasks such as detecting the status of each active instance of any open web browser program so that appropriate actions may be performed.

Two conditional processes 1206 are also maintained and monitored by the intermediate message display process. The conditional processes include a “quit” process and a “progress change” process. These conditional processes are executed whenever any active web browser application quits, or when any active web browser application updates its progress bar, respectively. In general, when a web browser event object (an active foreground browser window) quits, usually by closing the window, the ad screen is retracted, and the list of shell windows is cleared and a fresh list of shell window objects is initialized.

The next steps in FIG. 12 describe the execution of the rules that govern the display and hiding of the advertising message display screen. First, in step 1208, it is determined whether an active web browser window is currently in the foreground, i.e., displayed as the topmost window in the client GUI. To do this, a loop is executed that begins by grabbing each object element in the shell windows list. The sequence proceeds to assign the ID (handle) of the foreground window (also referred to as the active window). A conditional statement tests if foreground window matches with a web browser window and not just some other type of shell window object (such as the ‘My Computer’ window in the Microsoft Windows GUI).

If it is determined that a web browser window is an active foreground window, a series of rules is then applied to determine how the advertising message is to be displayed. The first rule is that if the ad message screen is not the foreground window and no web browser application is in the foreground, then the ad message is retracted (hidden), step 1220. Evaluation of this rule is included in the step 1208 decision block in FIG. 12. If the web browser is active, the process waits for a context switch event, such as the loading of a new web page, step 1210. When a context switch event is detected the ad timer process is started. This timer measures the duration that the ad message is displayed, and is only incremented when an ad message is displayed.

In one embodiment, a minimum ad time is set in the minimum ad time variable. This sets the minimum time for the ad to be allowed to retract. In step 1212 it is determined whether the ad timer value exceeds the minimum ad time value. If the ad timer is less than the minimum ad time value, the ad message is hidden, step 1220. If the ad timer is greater than the minimum ad time value, the process proceeds from step 1214. Once a new page is being loaded, its load progress, as displayed in a progress bar of the web browser, is monitored to determine the percentage of the page loaded, step 1214. If it exceeds a predetermined value, as set in the maximum percentage variable (e.g., 60%), the advertisement message is hidden. If the new page has not reached the maximum permissible loading percentage, the ad message is displayed in the ad screen, step 1216.

In one embodiment, an ad may be programmed to be displayed for a maximum amount of time. For this embodiment, the process next checks to determine whether the elapsed ad display time exceeds a maximum ad display time variable, step 1218. This variable can be used to limit the display duration of an ad message to allow other messages to be displayed if the context switch period is relatively long. When the advertising message is displayed, step 1216, the ad flag setting is set to ‘true’ to tell the program that the ad screen is active. The program then makes the ad screen a foreground screen so that no other window may overlap it. Canceling the advertising message involves setting the ad flag to ‘false’ to tell the program that the ad screen is inactive, the ad is then retracted by a process that hides the ad display screen, step 1220.

In certain applications, the display of an intermediate message may be allowed to extend for a certain minimum amount of time, regardless of the completion of the context switch event. For example, a particular ad message may be set to be displayed for a minimum of 8 seconds, regardless of whether the new web page is fully loaded or not. In this embodiment, the intermediate message display program includes a routine that suspends the loading of the new web page until the minimum display time elapses.

In one embodiment, the context switch process is used in a targeted advertising system that is configured to show any stored advertisement within a databank or ad repository. A targeted ad is a relevant ad message distributed to a target audience, and can be distributed based on the fact that the act of an Internet search or other act is a clue to what user is looking for. The relevant ad can then be served up with the search results in a pre-defined area of the web browser, such as in the right column (for example, an area for sponsors or sponsored search results). Similarly, during a context switching event, the process can be configured to store the last ten, or similar number of websites that user visited and display targeted relevant ads during context switching. For example, if a user first visits an apparel site, followed by a news site, then a web blog site and is in process to visit say, a social network personal page, the context switching process might first preload an apparel related ad based on first visit into local storage and during switch from blog site to the next site, serve up a more comprehensive short video ad message. The tracking of past visited web sites may be facilitated by client resident processes, such as ‘cookies’ or other tracking technologies. The context switch process could also be configured to capture and temporarily store the past few search terms entered in search engine as well. The picture built up from these sources can then be used to refine ads served up from the context switch repository of ad messages.

The intermediate display process 105 may be linked through network 110 to social networking sites that provide access by client computer 102 to other client computers, rather than a single server 104 or content provider 103. In this case, the intermediate message displayed in display area 212 may be user generated content provided by other users within the social network, and can include content such as pictures, video clips, text messages, annotated third party content, points of interest information, events, calendar information, and so on.

Although embodiments have been described with respect to the display of advertisement or similar message, aspects can also be directed to the use of an intermediate display process that facilitates multi-user interaction with respect to a common document or object. For example, the intermediate message may constitute a widget that facilitates editing functions or the display of edit comments on a word processing, or similar type of document. Such an element would be displayed in a clear space portion of the document.

Web Browser Implementation

As illustrated in FIG. 1, the intermediate message display process is provided as a client side program 105, typically a web browser applet. The server side intermediate display process 112 is used in this instance only to download the client side process 105 to the client computer, and facilitate the downloading of intermediate message content data from the server 104 or content provider 103 to the client 102 local memory. Alternatively, the intermediate message display process executed on the client web browser can be implemented as a server side program, or web server servlet 112. In this case, the intermediate message data is provided by the server through the server side program 112. This alternative embodiment may impose an additional overhead of increased traffic between the client and server computers during a context switching event.

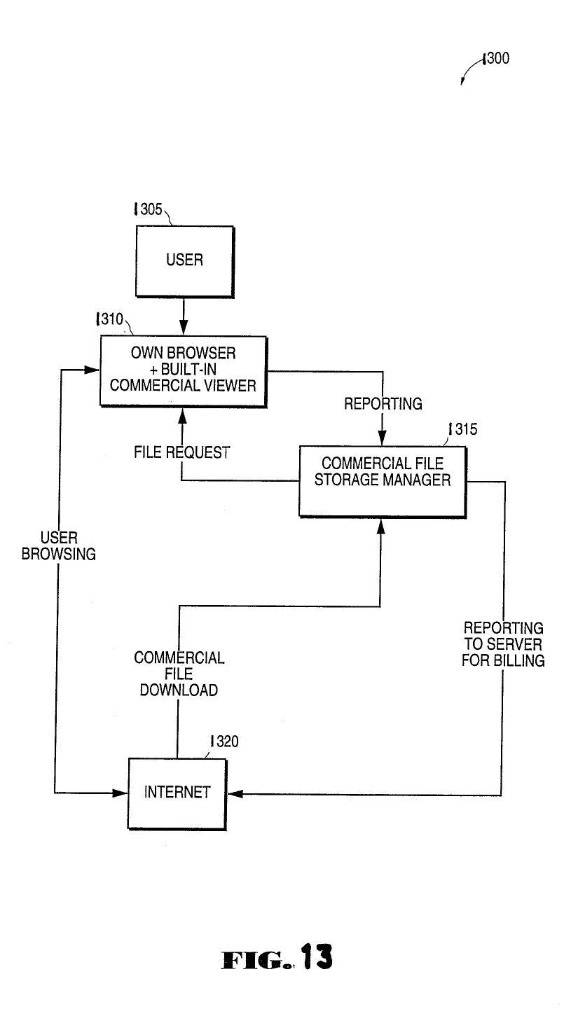

In one embodiment of the present invention, a dedicated client web browsing process can be used to incorporate the intermediate message display process. A block diagram of this embodiment is illustrated in FIG. 13. In system 1300, a user 1305 interfaces with a dedicated web browser program that incorporates a built-in commercial viewer (message display program) 1310. Upon the occurrence of a context switch event, the browser reports the event to a commercial file storage manager and generates a file request that serves to upload a message or data file from the commercial file storage manager 1315 to browser 1310. The commercial file storage manager 1315 requests a download of the message file from a file repository or storage device, such as may be maintained by a server 104 or content provider 103 via the Internet 1320. If the message download is part of a revenue bearing event, such as may be used in an e-commerce system, the message upload to the browser 1310 is reported to the commercial file storage manager 1315 for further processing or transmission to the appropriate server. The embodiment illustrated in FIG. 13 has the relative advantages of providing the user with full control over windows and objects displayed in the intermediate message display window, as well as the possibility of customizing display characteristics and parameters. This embodiment also provides more convenient implementation of specific display characteristics, such as timing optimizers, and the like. The embodiment illustrated in FIG. 13, however, can require more programming and integration requirements since a standard web browser is substituted for a custom developed browser. Furthermore, development time and support requirements might also be increased over alternative embodiments.

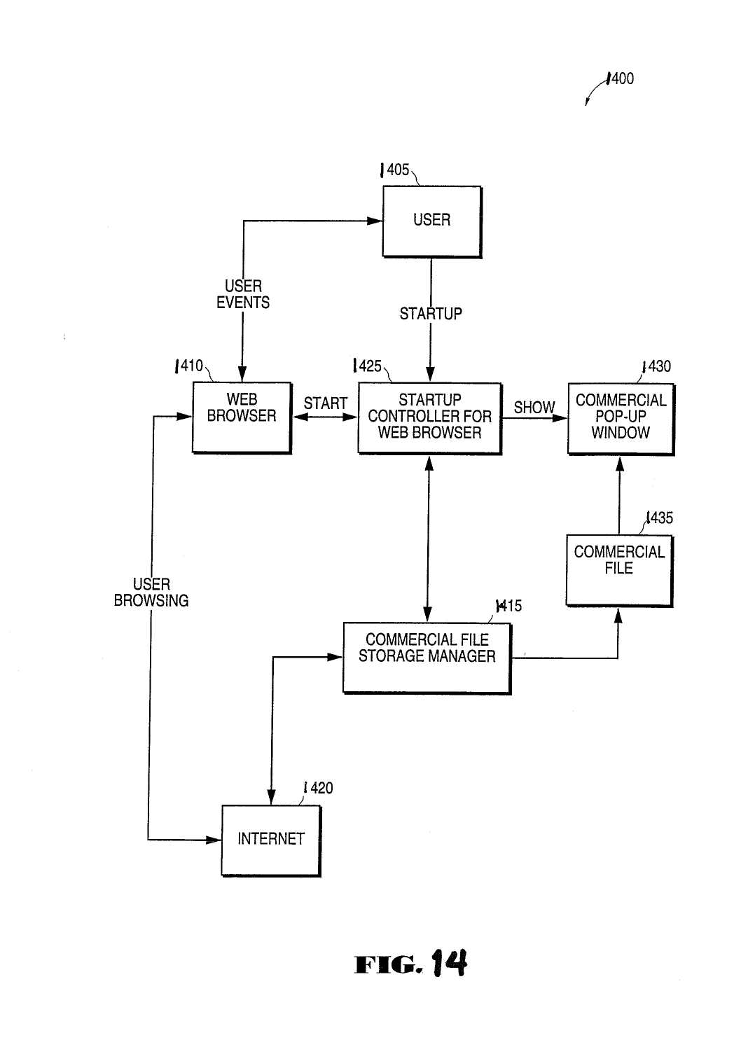

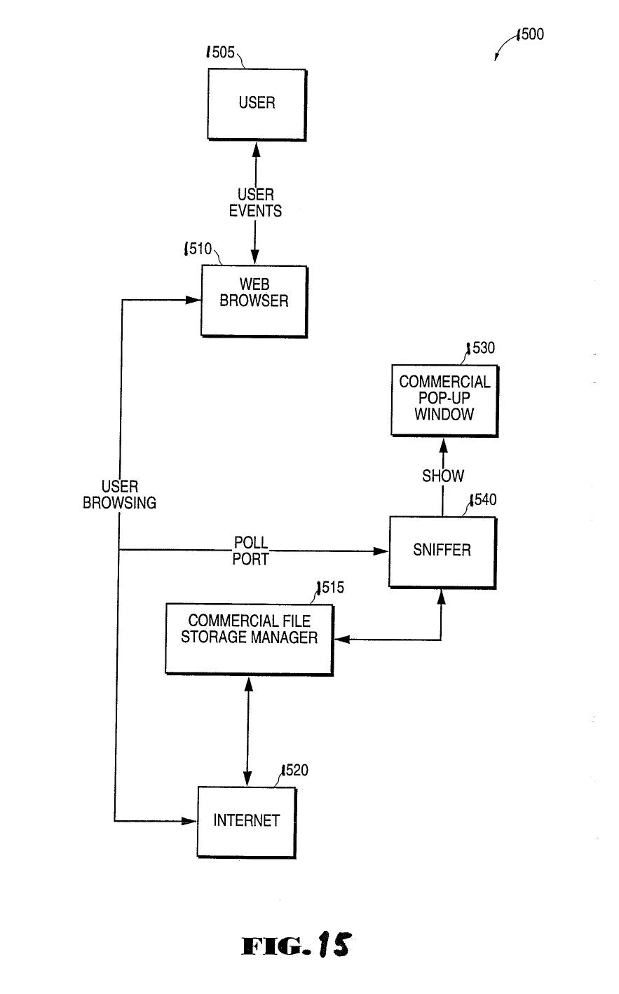

FIG. 14 is a block diagram that illustrates an intermediate message display process integrated with a standard web browser, according to an alternative embodiment. In system 1400 the user 1405 access web browser 1410 which is running on his or her client computer. Upon initial execution and start up of the browser process 1410, a startup control process 1425 for the intermediate message display process is invoked. The startup control process 1425 loads certain routines and sets parameters that control the generation and display of the intermediate messages provided by the commercial file storage manager 1415. The startup control process 1425 also includes a URL redirect process that redirects the web browser to the commercial file server location upon the need to upload the intermediate message. Upon the occurrence of an appropriate event or context switch, the commercial file storage manager 1415 uploads the specified message or commercial file 1435 to be displayed in the commercial pop-up window 1430 on the user web browser 1410. The commercial file storage manager 1425 is coupled to a file storage repository through the Internet 1420.

The embodiment illustrated in FIG. 14 has the relative advantages of using existing web browser technologies and programs that may already be loaded on the client computer. This embodiment also provides a faster development time due to use of existing programs and less support requirements, as well as a smaller foot print (program size) for deployment. The embodiment illustrated in FIG. 14, however, can impose a degree of complexity to the extent that different versions of the intermediate message display process are required for different web browsers. Furthermore, the use of standardized programs makes it more difficult to program and control user actions over alternative embodiments, such as that illustrated in FIG. 13.

For the embodiments illustrated in FIGS. 13 and 14, the generation and display of the intermediate message is triggered by user initiated actions, such as switching from one web page to another web page. In one embodiment of the present invention, the action that causes the display of an intermediate message can be triggered by a non-user initiated action. For example a network transmission switch or HTTP event can be used to trigger the display of an intermediate message on the user's web browser.

FIG. 15 is a block diagram that illustrates an intermediate message display process integrated with a standard web browser, according to a further alternative embodiment. In system 1500 the user 1505 can access the Internet 1520 through a web browser program 1510. A sniffer program 1540, which resides on either the client side or server side intermediate message display program, initiates a polling process to periodically check for the occurrence of a display triggering event. Such an event can be a network initiated event, such as a web page switch caused by a hidden HTML link, or similar type of context switch. Upon the occurrence of such an event, the sniffer process requests a message or data file from a commercial file storage manager 1515. Upon transmission of the message or data file, the sniffer process 1540 causes the display of the message on a commercial pop-up window 1530 on the user web browser 1510.

The embodiment illustrated in FIG. 15 has the relative advantages of being browser independent, that is the polling and sniffing processes can be written as stand-alone processes that are independent of the particular web browser 1510 utilized by the user. Furthermore, such processes can be made quite compact thereby providing a small footprint for deployment. The embodiment illustrated in FIG. 15 requires greater implementation effort since particular network triggering events must be identified and accommodated. Although there is a degree of browser independence, there is a dependence upon particular hardware, driver, and network implementations. This can result in longer development times compared to other embodiments, such as those illustrated in FIGS. 13 and 14. In one embodiment of the present invention, the transmission client/server software is implemented in a network that utilizes point to point telephony infrastructure. It is to be noted, however, that alternative embodiments can be implemented for use with point to point video conferencing or point to multi-point homing, or similar network systems. In addition, embodiments of the present invention can be implemented over networks that partially or wholly implement wireless data communication technology.

In one embodiment, the overall system intermediate message display system may include a web page analyzer that includes web crawlers that analyze a large number of web pages for consistent or typical empty unused spaces. The most frequently visited web pages can be cataloged to index the areas in each page containing empty spaces of certain dimensions. A database accessible to the process can store such pages. During loading of such pages, the intermediate message display process can be configured to target the identified clearspace of these pages.

Any of the displayed intermediate messages can be any type of static or dynamic message with text messages, video content, audio content, hyperlinks, applets, and the like, and any combination thereof. During any latency within the system due to context switching and the like, the intermediate message display window may be expanded to fill the entire or a majority of the display area for a brief period of time. In this manner, the intermediate message may be displayed through modules that exploit both the clear space or defined space (e.g., taskbar) as well as the latent time (e.g., context switch period) of the window. This provides advertisers and other intermediate message providers a way to exploit both the time and space dimensions of availability within web pages.

Aspects of the intermediate display process can also be applied to applications as opposed to web browser displayed web pages. For example, office applications such as word processors, spreadsheets and the like display documents or objects that include clear spaces or defined spaces that do not have usable content. Such areas can be exploited for the display of intermediate messages or applets provided by the host application, other applications, or even other networked computers. For example, a word processing page may utilize an intermediate message display process to allow users to edit a document and have their respective individual edits displayed in various clear spaces of the document. This prevents any interference or obstruction of the actual content and facilitates interaction among multiple users. Similarly a mapping process may allow geotagging by users by displaying useful comments in certain areas of a displayed map.

Although some of the figures and associated description are largely directed to embodiments that utilize technology that is specific to the Internet and the World Wide Web, it should be noted that embodiments of the present invention can also be used in the context of other networked computer systems, such as local area networks, wide area networks, and other proprietary networks.

In the foregoing, a system has been described for generating and displaying intermediate messages in the unused area on a client web browser. Although the present invention has been described with reference to specific exemplary embodiments, it will be evident that various modifications and changes may be made to these embodiments without departing from the broader spirit and scope of the invention-as set forth in the claims. Accordingly, the specification and drawings are to be regarded in an illustrative rather than a restrictive sense.

Embodiments described herein may be applied to, or implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described system may be embodied in microprocessors having software-based circuit emulation, discrete logic (sequential and combinatorial), custom devices, fuzzy (neural) logic, quantum devices, and hybrids of any of the above device types. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments is not intended to be exhaustive or to limit the embodiments to the precise form or instructions disclosed. While specific embodiments of, and examples for, the system are described herein for illustrative purposes, various equivalent modifications are possible within the scope of the described embodiments, as those skilled in the relevant art will recognize. The elements and acts of the various embodiments described above can be combined to provide further embodiments. These and other changes can be made to the system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the system may be presented in certain claim forms (if claims are present), the inventor contemplates the various aspects of the methodology in any number of claim forms. For example, while only one aspect of the system is recited as embodied in machine-readable medium, other aspects may likewise be embodied in machine-readable medium.

What is claimed is:

1. A method of displaying an intermediate message in an active display area of a network client computer, comprising the steps of:
identifying an unused display space within the active display area, the unused display space comprising pixels of a uniform value maintained for a first pre-defined time period;
quantifying a size and shape of the unused display space;
monitoring user activity within a region of the display area; and
displaying an intermediate message of appropriate size in the unused display space or in the region of the display area if there is no monitored user activity for a second pre-defined period of time.

2. The method of claim 1 further comprising the steps of:
monitoring the state of the active display area to determine if there is a change in content of the active display area to produce a new active display area;
measuring an idle time representing the time required to effect the change in content of the active display area; and
displaying an intermediate message of appropriate size in the unused display space or during the idle time if there is a change in content of the active display area.

3. The method of claim 1 wherein the unused display space comprises clear space within a content display area of a web browser window displayed on a client computing device.

4. The method of claim 3 wherein the step of identifying an unused display space within the active display area comprises analyzing a pre-defined area around the perimeter of the display space and moving successively inward until unused display space is located.

5. The method of claim 1 wherein the unused display space comprises the taskbar area of a web browser window displayed on a client computing device.

6. The method of claim 1 wherein the intermediate message is an advertising text message generated and provided to the client computer by a third party content provider coupled to the client computer over a computer network.

7. The method of claim 1 wherein the intermediate message comprises a widget.

8. The method of claim 1 wherein the client computer is coupled to a web server computer over the Internet network, and wherein the client computer executes client processes operable to transmit and receive data files over the World Wide Web portion of the Internet, and further wherein the web page data comprises Hypertext Markup Language (HTML) data executable by the client processes.

9. The method of claim 8 wherein the client computer is a mobile communication device.

10. The method of claim 1 further comprising:
analyzing a plurality of web pages through a web crawler process to determine a number of web pages that include clear space areas; and
indexing the web pages that include clear space areas.

11. The method of claim 1 wherein the intermediate message comprises a sequentially displayed series of words or phrases.

12. A method of displaying an intermediate message in an active display area of a network client computer, comprising the steps of:
identifying an unused display space within the active display area, the unused display space comprising pixels of a uniform value maintained for a first pre-defined time period;
monitoring the state of the active display area to determine if there is a context switch of the active display area to display new content in the active display area;
measuring an idle time representing the time required to effect the context switch of the active display area;
displaying an intermediate message as a full page display during the idle time if there is a context switch of the active display area; and
displaying an intermediate message of appropriate size in the unused display space if there is not a context switch of the active display area.

13. The method of claim 12 further comprising the steps of:
monitoring user activity within a region of the display area; and
displaying the intermediate message if there is no monitored user activity for a second pre-defined period of time.

14. The method of claim 12 wherein the context switch is due to one of scrolling entire display area from a first page to a second page, or loading a new web page from a first network address to second network address.

15. The method of claim 14 wherein the intermediate message is an advertising text message generated and provided to the client computer by a third party content provider coupled to the client computer over a computer network.

16. The method of claim 15 wherein the client computer is coupled to a web server computer over the Internet network, and wherein the client computer executes client processes operable to transmit and receive data files over the World Wide Web portion of the Internet, and further wherein the web page data comprises Hypertext Markup Language (HTML) data executable by the client processes.

17. The method of claim 16 wherein the client computer is a mobile communication device.

18. The method of claim 12 wherein the unused display space comprises clear space within a content display area of a web browser window displayed on a client computing device.

19. The method of claim 18 wherein the step of identifying an unused display space within the active display area comprises analyzing a pre-defined area around the perimeter of the display space and moving successively inward until unused display space is located.

20. The method of claim 19 wherein the unused display space comprises the taskbar area of a web browser window displayed on a client computing device.
